(19) United States
(12) Patent Application Publication
(10) Pub. No.: US 2026/0045884 A1
(43) Pub. Date: Feb. 12, 2026

(54) LLC CONVERTER CONTROL CIRCUIT AND LLC CONVERTER

(71) Applicant: SANKEN ELECTRIC CO., LTD., Niiza-Shi (JP)

(72) Inventor: Shinji ASO, Niiza-Shi (JP)

(21) Appl. No.: 19/266,515

(22) Filed: Jul. 11, 2025

(30) Foreign Application Priority Data
Aug. 9, 2024 (JP) 2024-134217

(51) Int. Cl. H02M 3/335; H02M 1/00; H02M 3/00

(52) U.S. Cl. CPC H02M 3/33571; H02M 1/0009; H02M 3/01

(57) ABSTRACT

An LLC converter control circuit according to one or more embodiments may include a current detection circuit, a synchronization signal generation circuit, an edge delay circuit, a ramp voltage generation circuit, and a driving signal generation circuit. The current detection circuit outputs a zero cross signal. The synchronization signal generation circuit outputs a first signal indicating a value that is a resultant of an exclusive OR operation on respective values of a first driving signal and the zero cross signal. The edge delay circuit outputs a delay signal, which is the first signal delayed by a predetermined time. The ramp voltage generation circuit outputs a ramp voltage by charging and discharging a feedback current into and from a capacitor, based on a change in level of the delay signal. The driving signal generation circuit generates the first driving signal and a second driving signal, based on the ramp voltage.

### CROSS-REFERENCE TO RELATED APPLICATIONS

This application claims priority from Japanese Patent Application No. 2024-134217 filed on Aug. 9, 2024, the entire contents of which are hereby incorporated by reference.

### BACKGROUND

The disclosure relates to an inductor-inductor-capacitor (LLC) converter control circuit and an LLC converter.

Techniques have been proposed in regard to an apparatus for controlling a switching circuit for an LLC converter. For example, Japanese Unexamined Patent Application Publication (JP-A) No. 2011-083186 discloses a control device for resonant converters. The control device for the resonant converters disclosed in JP-A No. 2011-083186 charges and discharges a capacitor with a feedback current and controls a half bridge of an LLC converter, based on respective times of charging and discharging.

### SUMMARY

An LLC converter control circuit according to one or more embodiments may be configured to control a high side driving signal and a low side driving signal, based on a resonant-current-converted voltage. The high side driving signal is adapted to drive a high side switch. The low side driving signal is adapted to drive a low side switch. The resonant-current-converted voltage is a voltage as a resultant of conversion from a current flowing through a resonant circuit configured to resonate through alternate turning-on and turning-off of the high side switch and the low side switch. An LLC converter control circuit according to one or more embodiments may include a current detection circuit, a synchronization signal generation circuit, an edge delay circuit, a ramp voltage generation circuit, and a driving signal generation circuit. The current detection circuit is configured to perform a comparison between the resonant-current-converted voltage and a ground potential and to output a zero cross signal whose voltage level is to change at a timing at which the resonant-current-converted voltage switches to a positive potential or a negative potential. The synchronization signal generation circuit may be configured to output a first signal indicating a value that is a resultant of an exclusive OR operation on respective values of a first driving signal and the zero cross signal. The first driving signal is adapted to generate the high side driving signal. The edge delay circuit may be configured to output a delay signal. The delay signal is the first signal delayed by a predetermined time. The ramp voltage generation circuit is configured to output a ramp voltage by charging and discharging a current supplied from a feedback terminal into and from a capacitor, based on a change in level of the delay signal. The driving signal generation circuit may be configured to generate, based on the ramp voltage, the first driving signal adapted to generate the high side driving signal and a second driving signal adapted to generate the low side driving signal.

An LLC converter according to one or more embodiments may include an LLC converter control circuit, an input power supply, a half bridge circuit, a resonant circuit, a first diode, a second diode, an output capacitor, an output voltage detection circuit, and a resonant current detection circuit. The half bridge circuit includes a high side switch and a low side switch. The resonant circuit is coupled between an output of the half bridge circuit and a ground, and includes a primary winding of a transformer and a resonant capacitor that are coupled in series to each other. The first diode, the second diode, and the output capacitor may be configured to rectify and smooth a current flowing through a secondary winding of the transformer. The output voltage detection circuit may be configured to detect an output voltage. The resonant current detection circuit may be configured to detect a current flowing through the resonant circuit. The LLC converter control circuit may be configured to control a high side driving signal and a low side driving signal, based on a resonant-current-converted voltage. The high side driving signal may be adapted to drive the high side switch. The low side driving signal is adapted to drive the low side switch. The resonant-current-converted voltage is a voltage as a resultant of conversion from the current flowing through the resonant circuit. The resonant circuit may be configured to resonate through alternate turning-on and turning-off of the high side switch and the low side switch. The LLC converter control circuit includes a current detection circuit, a synchronization signal generation circuit, an edge delay circuit, a ramp voltage generation circuit, and a driving signal generation circuit. The current detection circuit may be configured to perform a comparison between the resonant-current-converted voltage and a ground potential and to output a zero cross signal whose voltage level is to change at a timing at which the resonant-current-converted voltage switches to a positive potential or a negative potential. The synchronization signal generation circuit may be configured to output a first signal indicating a value that is a resultant of an exclusive OR operation on respective values of a first driving signal and the zero cross signal. The first driving signal may be adapted to generate the high side driving signal. The edge delay circuit is configured to output a delay signal. The delay signal is the first signal delayed by a predetermined time. The ramp voltage generation circuit may be configured to output a ramp voltage by charging and discharging a current supplied from a feedback terminal into and from a capacitor, based on a change in level of the delay signal. The driving signal generation circuit may be configured to generate, based on the ramp voltage, the first driving signal adapted to generate the high side driving signal and a second driving signal adapted to generate the low side driving signal.

### BRIEF DESCRIPTION OF THE DRAWINGS

The accompanying drawings are included to provide a further understanding of the disclosure, and are incorporated in and constitute a part of this specification. The drawings illustrate one or more embodiments and, together with the specification, serve to explain the principles of the disclosure.

FIG. 1 is a diagram illustrating a configuration of an LLC converter according to one or more embodiments.

FIG. 2 is a diagram for describing an LLC converter control circuit of a comparative example.

FIG. 3 is a diagram illustrating a configuration of an LLC converter control circuit according to a first example embodiment or embodiments.

FIG. 4 is a diagram illustrating the configuration of the LLC converter control circuit according to a first example embodiment or embodiments.

FIG. 5 is a diagram for describing an operation of the LLC converter control circuit according to a first example embodiment or embodiments.

FIG. 6 is a diagram for describing an operation of the LLC converter control circuit according to a first example embodiment or embodiments.

FIG. 7A is a diagram for describing an operation of the LLC converter control circuit of the comparative example such as is illustrated in FIG. 2.

FIG. 7B is a diagram for describing an operation of the LLC converter control circuit of the comparative example such as is illustrated in FIG. 2.

FIG. 8 is a diagram for describing an operation of the LLC converter control circuit according to a first example embodiment or embodiments.

FIG. 9 is a diagram for describing an operation of the LLC converter control circuit according to a first example embodiment or embodiments.

FIG. 10 is a graph illustrating a relationship between an output current and a feedback current in an LLC converter according to a first example embodiment or embodiments.

FIG. 11 is a diagram illustrating a configuration of an LLC converter control circuit according to a second example embodiment or embodiments.

FIG. 12 is a diagram illustrating the configuration of the LLC converter control circuit according to a second example embodiment or embodiments.

FIG. 13 is a diagram for describing an operation of the LLC converter control circuit of the comparative example such as is illustrated in FIG. 2.

FIG. 14 is a diagram for describing an operation of the LLC converter control circuit according to a second example embodiment or embodiments.

FIG. 15 is a diagram for describing an operation of the LLC converter control circuit according to a second example embodiment or embodiments.

FIG. 16 is a diagram for describing an operation of the LLC converter control circuit according to a second example embodiment or embodiments.

FIG. 17 is a graph illustrating a relationship between an output current and a feedback current in an LLC converter according to a second example embodiment or embodiments.

FIG. 18 is a graph illustrating a relationship between the output current and the feedback current obtained with varying input voltage in the LLC converter according to a second example embodiment or embodiments.

FIG. 19 is a diagram for describing an operation of an LLC converter control circuit according to a third example embodiment or embodiments.

FIG. 20 is a diagram for describing an operation of the LLC converter control circuit according to a third example embodiment or embodiments.

FIG. 21 is a diagram illustrating a configuration of the LLC converter control circuit according to the third example embodiment of the disclosure.

FIG. 22 is a diagram illustrating the configuration of the LLC converter control circuit according to a third example embodiment or embodiments.

FIG. 23 is a diagram illustrating a first other configuration example of the LLC converter control circuit according to a third example embodiment or embodiments.

FIG. 24 is a diagram illustrating the first other configuration example of the LLC converter control circuit according to a third example embodiment or embodiments.

FIG. 25 is a diagram illustrating a second other configuration example of the LLC converter control circuit according to a third example embodiment or embodiments.

FIG. 26 is a diagram illustrating the second other configuration example of the LLC converter control circuit according to a third example embodiment or embodiments.

FIG. 27 is a diagram for describing an operation of the LLC converter control circuit such as is illustrated in FIGS. 23 and 24.

FIG. 28 is a diagram for describing comparisons of operations between the LLC converter control circuits according to a second and third example embodiments.

FIG. 29 is a graph illustrating a relationship between an output current and a feedback current in each of the LLC converter control circuits such as is illustrated in FIGS. 21 to 26.

### DETAILED DESCRIPTION

For example, in an LLC converter, a phase difference that a load current is to cause between a periodic square wave voltage and a zero cross signal is 0° at a maximum output current, that is, there is no phase difference between the periodic square wave voltage and the zero cross signal under such a condition. However, at no load, a 90° phase difference occurs therebetween to cause the zero cross signal to lag behind the periodic square wave voltage. Accordingly, when the phase difference is 90°, a slope of a sawtooth wave voltage (a ramp voltage) for generating a driving signal exhibits a maximum of a twofold change. Further, a feedback current also exhibits a maximum of a twofold change based on a slope of the feedback current. At light load, because the change in the feedback current based on the slope thereof is no more than twofold, it is difficult to accurately detect an output current, based on the feedback current.

It is desirable to provide an LLC converter control circuit and an LLC converter that each make it possible to accurately detect a value of an output current even in a region where the output current is small.

An LLC converter 10 and an LLC converter control circuit 100 according to one or more embodiments is described in detail below with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### Configuration of LLC Converter 10

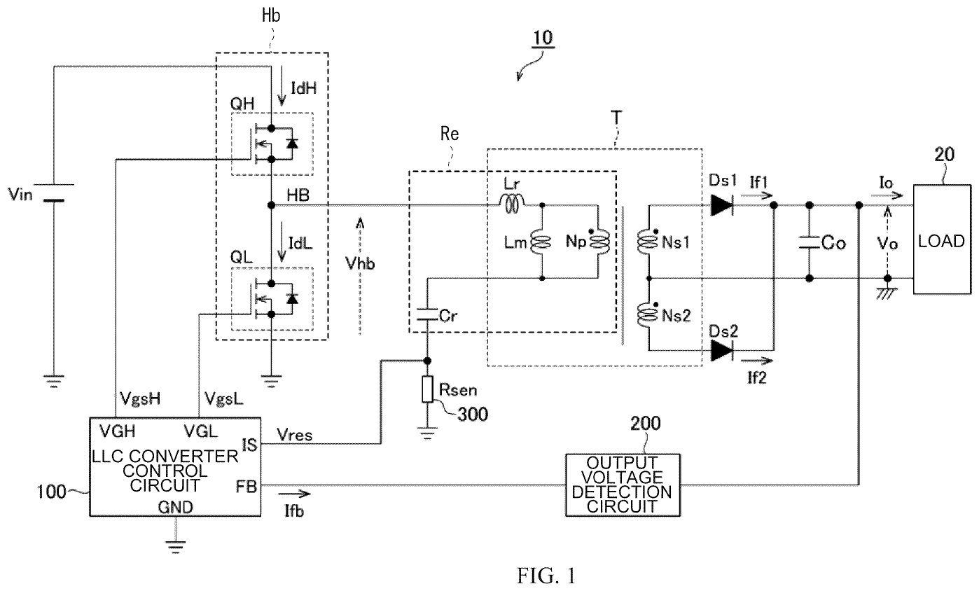

FIG. 1 illustrates a configuration of the LLC converter 10 including the LLC converter control circuit 100 according to an embodiment of the disclosure. The LLC converter 10 may correspond to a specific but non-limiting example of an “LLC converter” according to one or more embodiments. The LLC converter control circuit 100 may correspond to a specific but non-limiting example of an “LLC converter control circuit”according to one or more embodiments.

The LLC converter 10 includes an input power supply Vin and a half bridge circuit Hb. The half bride circuit Hb may be coupled to the input power supply Vin. The half bridge circuit Hb includes a high side switch QH and a low side switch QL. The LLC converter 10 further includes a resonant circuit Re. The resonant circuit Re is coupled between an output HB of the half bridge circuit Hb and a ground GND, and includes a primary winding Np of a transformer T and a resonant capacitor Cr that are coupled in series to each other. The half bridge circuit Hb may correspond to a specific but non-limiting example of a “half bridge circuit” according to one or more embodiments. The resonant circuit Re may correspond to a specific but non-limiting example of a “resonant circuit”according to one or more embodiments.

The LLC converter 10 further includes a first diode Ds1, a second diode Ds2, and an output capacitor Co that rectify and smooth a current flowing through secondary windings Ns1 and Ns2 of the transformer T. The LLC converter 10 further includes an output voltage detection circuit 200 that detects an output voltage Vo. The LLC converter 10 further includes a resonant current detection circuit 300 that detects a current flowing through the resonant circuit Re. The first diode Ds1 may correspond to a specific but non-limiting example of a “first diode” according to one or more embodiments. The second diode Ds2 may correspond to a specific but non-limiting example of a “second diode” according to one or more embodiments. The output capacitor Co may correspond to a specific but non-limiting example of an “output capacitor” according to one or more embodiments. The output voltage Vo may correspond to a specific but non-limiting example of an “output voltage” according to one or more embodiments. The output voltage detection circuit 200 may correspond to a specific but non-limiting example of an “output voltage detection circuit” according to one or more embodiments. The resonant current detection circuit 300 may correspond to a specific but non-limiting example of a “resonant current detection circuit”according to one or more embodiments.

The LLC converter 10 further includes the LLC converter control circuit 100. The LLC converter control circuit 100 may control the high side switch QH and the low side switch QL. The LLC converter control circuit 100 may control a high side driving signal VgsH and a low side driving signal VgsL, based on a feedback current Ifb of the output voltage detection circuit 200 and a voltage Vres at the resonant current detection circuit 300. The high side switch QH may correspond to a specific but non-limiting example of a “high side switch” according to one or more embodiments. The low side switch QL may correspond to a specific but non-limiting example of a “low side switch”according to one or more embodiments.

The voltage Vres represents a voltage as a resultant of conversion from the current flowing through the resonant circuit Re. The resonant circuit Re resonates through alternate turning-on and turning-off of the high side switch QH and the low side switch QL. The high side driving signal VgsH is adapted to drive the high side switch QH. The low side driving signal VgsL is adapted to drive the low side switch QL. In the LLC converter 10, the output voltage Vo may be controlled based on the high side driving signal VgsH and the low side driving signal VgsL. As described above, the voltage Vres is a voltage as a resultant of conversion from the current flowing through the resonant circuit Re. The voltage Vres may correspond to a specific but non-limiting example of a “resonant-current-converted voltage” according to one or more embodiments. The high side driving signal VgsH may correspond to a specific but non-limiting example of a “high side driving signal” according to one or more embodiments. The low side driving signal VgsL may correspond to a specific but non-limiting example of a “low side driving signal” according to one or more embodiments.

### Configuration of LLC Converter Control Circuit 100

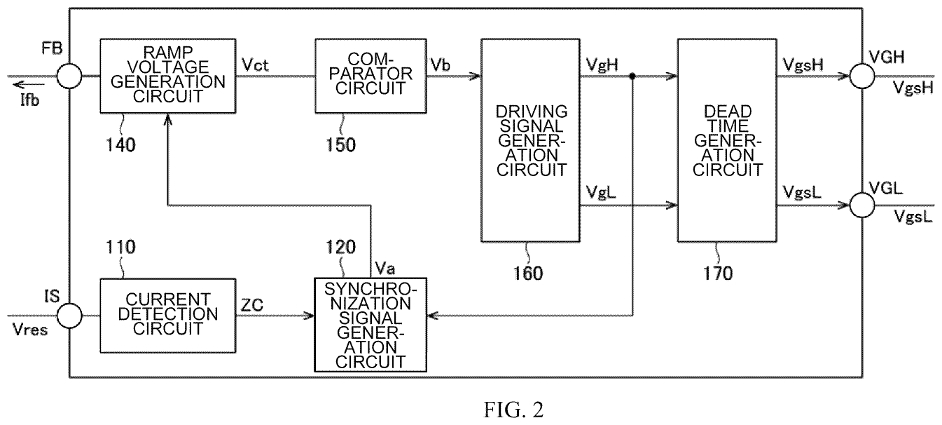

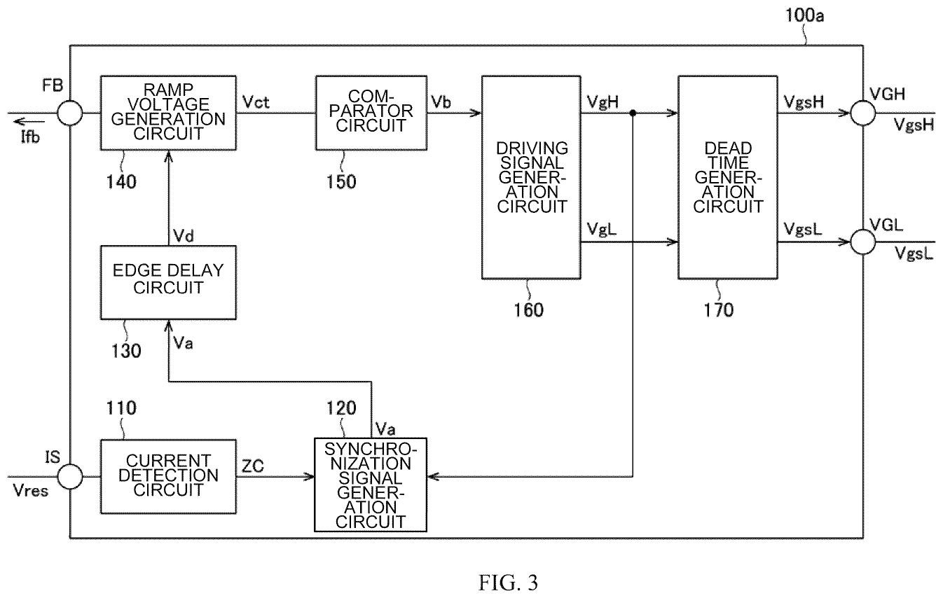

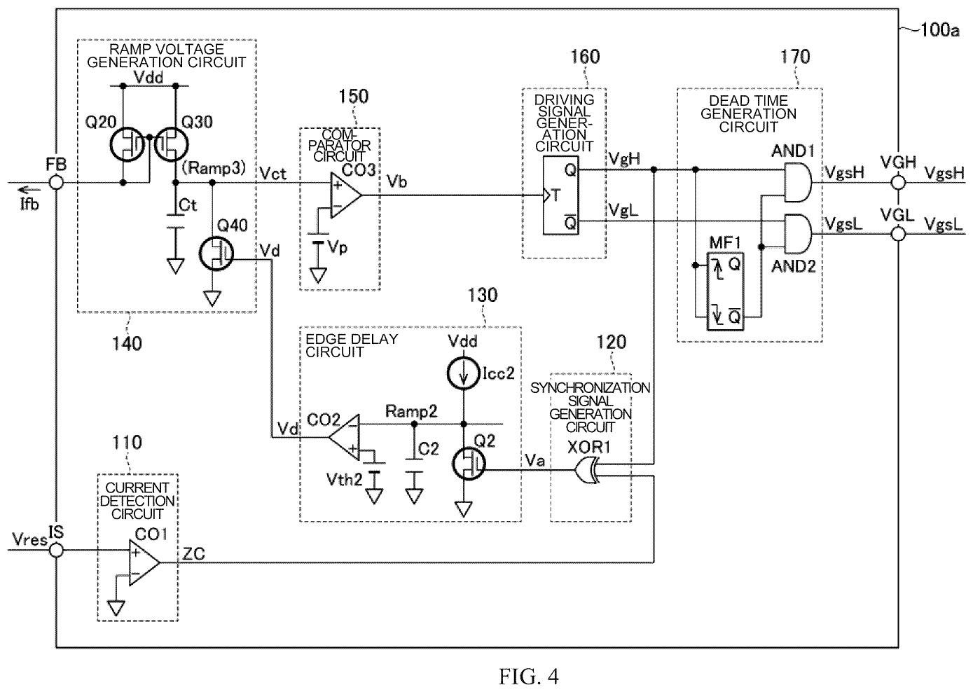

FIG. 2 is a diagram for describing an LLC converter control circuit of a comparative example. FIGS. 3 and 4 are diagrams illustrating a configuration of an LLC converter control circuit 100a according to a first example embodiment. Hereinafter, the LLC converter control circuit 100a according to the first example embodiment and LLC converter control circuits 100b to 100e according to respective subsequent example embodiments to be described later will each be simply referred to as the “LLC converter control circuit 100” when these LLC converter control circuits are not to be distinguished from one another.

The LLC converter control circuit of the comparative example illustrated in FIG. 2 may include a current detection circuit 110, a synchronization signal generation circuit 120, a ramp voltage generation circuit 140, a comparator circuit 150, a driving signal generation circuit 160, and a dead time generation circuit 170.

The current detection circuit 110 may perform a comparison between the voltage Vres at an IS terminal and a GND potential, and send out a zero cross signal ZC. The zero cross signal ZC may be at a high level (High) when the voltage Vres is positive, and may be at a low level (Low) when the voltage Vres is negative. In other words, the current detection circuit 110 performs a comparison between the voltage Vres and the GND potential, and outputs the zero cross signal ZC whose voltage level is to change at a timing at which the voltage Vres switches to a positive potential or a negative potential. The zero cross signal ZC may correspond to a specific but non-limiting example of a “zero cross signal” according to one or more embodiments.

The synchronization signal generation circuit 120 may generate a first signal Va by inputting a first driving signal VgH outputted from the driving signal generation circuit 160 and the zero cross signal ZC of the current detection circuit 110 to a circuit configured to perform an exclusive OR operation.

At a time at which the first signal Va outputted from the synchronization signal generation circuit 120 turns Low, the ramp voltage generation circuit 140 may start charging a capacitor Ct with the feedback current Ifb flowing through a feedback terminal FB. Further, the ramp voltage generation circuit 140 may discharge the capacitor Ct at a timing at which the first signal Va turns High, and may thereby output a ramp voltage Vct.

The comparator circuit 150 may perform a comparison between the ramp voltage Vct and a reference voltage Vp and send out a second signal Vb as a comparison result indicating a result of the comparison. The second signal Vb may turn High when the ramp voltage Vct exceeds the reference voltage Vp.

The driving signal generation circuit 160 may include a toggle flip-flop (T-FF). The T-FF may be configured to receive the second signal Vb, configured to output the first driving signal VgH from a Q output, and configured to output a second driving signal VgL from an NQ output. Further, the driving signal generation circuit 160 may toggle between the first driving signal VgH and the second driving signal VgL at a rising edge (a timing of rising) of the second signal Vb, i.e., the comparison result sent out by the comparator circuit 150.

The dead time generation circuit 170 may generate the high side driving signal VgsH and the low side driving signal VgsL by delaying respective timings of rising of the first driving signal VgH and the second driving signal VgL, and may output the high side driving signal VgsH and the low side driving signal VgsL to a VGH terminal and a VGL terminal, respectively.

### First Example Embodiment

The LLC converter control circuit 100a according to the first example embodiment illustrated in FIGS. 3 and 4 may include the components of the LLC converter control circuit of the comparative example illustrated in FIG. 2, and may further include an edge delay circuit 130. The current detection circuit 110 described with reference to FIG. 2 may correspond to a specific but non-limiting example of a “current detection circuit” according to one or more embodiments. The synchronization signal generation circuit 120 described with reference to FIG. 2 may correspond to a specific but non-limiting example of a “synchronization signal generation circuit” according to one or more embodiments. The ramp voltage generation circuit 140 described with reference to FIG. 2 may correspond to a specific but non-limiting example of a “ramp voltage generation circuit” according to one or more embodiments. The driving signal generation circuit 160 described with reference to FIG. 2 may correspond to a specific but non-limiting example of a “driving signal generation circuit” according to one or more embodiments. The edge delay circuit 130 illustrated in FIGS. 3 and 4 may correspond to a specific but non-limiting example of an “edge delay circuit”according to one or more embodiments.

The edge delay circuit 130 outputs a delay signal Vd. The delay signal Vd is the first signal Va delayed by a predetermined time. As illustrated in FIG. 4, the edge delay circuit 130 may charge a capacitor C2 with a current Icc2 from a constant current source when the first signal Va generated at the synchronization signal generation circuit 120 is at the low level (Low). Further, the edge delay circuit 130 may output the delay signal Vd, i.e., the first signal Va delayed by the predetermined time, until a voltage charged in the capacitor C2 reaches a threshold voltage Vth2. In other words, the edge delay circuit 130 may delay a time of falling of the first signal Va outputted from the synchronization signal generation circuit 120.

The first signal Va may correspond to a specific but non-limiting example of a “first signal” according to one or more embodiments. The delay signal Vd may correspond to a specific but non-limiting example of a “delay signal” according to one or more embodiments.

The LLC converter control circuit 100a according to the first example embodiment may thus delay a start time of charging of a voltage into the capacitor Ct provided in the ramp voltage generation circuit 140 from a zero-crossing time of a resonant current. In other words, the ramp voltage generation circuit 140 outputs the ramp voltage Vct by charging and discharging a current supplied from the feedback terminal FB into and from the capacitor Ct, based on a change in level of the delay signal Vd. The capacitor Ct may correspond to a specific but non-limiting example of a “capacitor” according to one or more embodiments. The feedback terminal FB may correspond to a specific but non-limiting example of a “feedback terminal” according to one or more embodiments. The ramp voltage Vct may correspond to a specific but non-limiting example of a “ramp voltage” according to one or more embodiments.

The foregoing configuration helps to allow the feedback current Ifb to exhibit a greater amount of change at near-zero load in the LLC converter 10 according to the first example embodiment. This in turn helps to allow the LLC converter control circuit 100a to accurately determine an extremely light load condition, based on the amount of change in the feedback current Ifb.

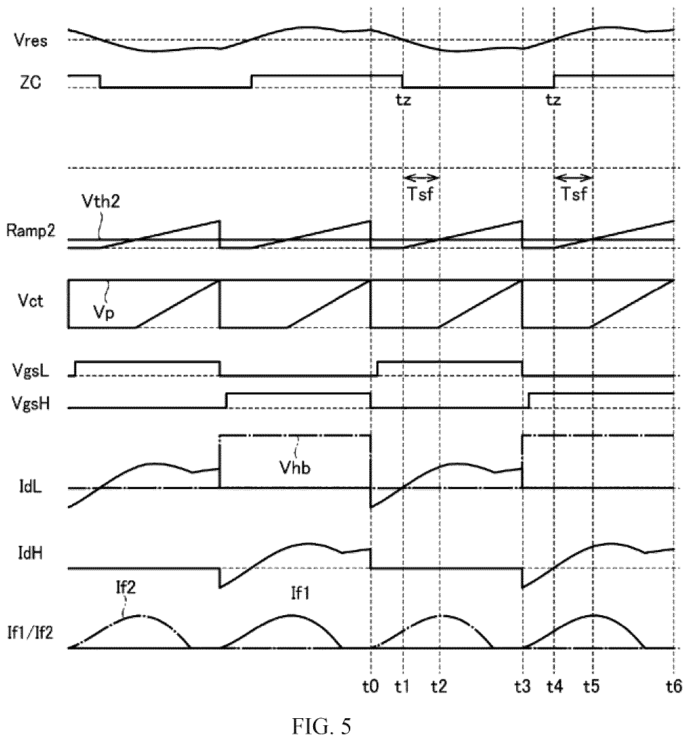

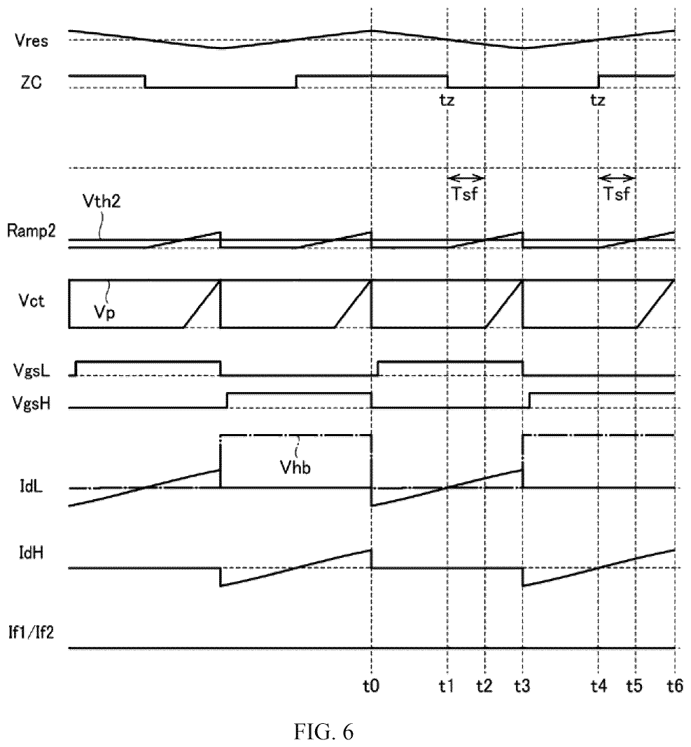

FIGS. 5 and 6 illustrate waveform examples representing operations of the LLC converter control circuit 100a according to the first example embodiment when a load 20 is a rated load and when the load 20 is zero, respectively.

### Operation at Rated Load

Reference is made to FIG. 5 to describe the operation at rated load. The current detection circuit 110 may perform a comparison between the voltage Vres at the IS terminal and the GND potential, and send out the zero cross signal ZC. The high side driving signal VgsH may turn off at a time t0.

Thereafter, at a time t1, the zero cross signal ZC outputted from the current detection circuit 110 may turn Low from High. Further, at the time t1, the edge delay circuit 130 may start charging the capacitor C2 with the current Icc2 set in advance. A voltage Ramp2 of the edge delay circuit 130 may start rising at the time t1.

Thereafter, at a time t2, the voltage Ramp2 may become higher than the threshold voltage Vth2 set in advance, and the capacitor Ct provided in the ramp voltage generation circuit 140 may start being charged with the feedback current Ifb. The ramp voltage Vct (a voltage Ramp3) of the ramp voltage generation circuit 140 may start rising at the time t2.

The threshold voltage Vth2 to be set in advance may be so determined as to cause a time of rising of the ramp voltage Vct, i.e., the time t2, to be delayed by a time Tsf from a zero-crossing time tz (the time t1) illustrated in FIG. 5.

Thereafter, at a time t3, the ramp voltage Vct may become higher than the reference voltage Vp determined in advance, and the low side driving signal VgsL may turn Low to control the low side switch QL to turn off.

Thereafter, at a time t4, the zero cross signal ZC of the current detection circuit 110 may turn High from Low. Further, at the time t4, the edge delay circuit 130 may start charging the capacitor C2 with the current Icc2 set in advance. The voltage Ramp2 of the edge delay circuit 130 may start rising again at the time t4.

At a time t5, the voltage Ramp2 may become higher than the threshold voltage Vth2, and the capacitor Ct provided in the ramp voltage generation circuit 140 may start being charged with the feedback current Ifb. Further, the ramp voltage Vct of the ramp voltage generation circuit 140 may start rising again at the time t5. At a time t6, the ramp voltage Vct may become higher than the reference voltage Vp determined in advance, and the high side driving signal VgsH may turn Low to control the high side switch QH to turn off.

### Operation at No Load

Next, reference is made to FIG. 6 to describe the operation at no load. The current detection circuit 110 may perform a comparison between the voltage Vres at the IS terminal and the GND potential, and send out the zero cross signal ZC. The high side driving signal VgsH may turn off at the time t0.

Thereafter, at the time t1, the zero cross signal ZC outputted from the current detection circuit 110 may turn Low from High. Further, at the time t1, the edge delay circuit 130 may start charging the capacitor C2 with the current Icc2 set in advance. The voltage Ramp2 of the edge delay circuit 130 may start rising at the time t1.

Thereafter, at the time t2, the voltage Ramp2 may become higher than the threshold voltage Vth2 set in advance, and the capacitor Ct provided in the ramp voltage generation circuit 140 may start being charged with the feedback current Ifb. The ramp voltage Vct (the voltage Ramp3) of the ramp voltage generation circuit 140 may start rising at the time t2.

The threshold voltage Vth2 to be set in advance may be so determined as to cause the time of rising of the ramp voltage Vct, i.e., the time t2, to be delayed by the time Tsf from the zero-crossing time tz (the time t1) illustrated in FIG. 6.

Thereafter, at the time t3, the ramp voltage Vct may become higher than the reference voltage Vp determined in advance, and the low side driving signal VgsL may turn Low to control the low side switch QL to turn off.

Thereafter, at the time t4, the zero cross signal ZC of the current detection circuit 110 may turn High from Low. Further, at the time t4, the edge delay circuit 130 may start charging the capacitor C2 with the current Icc2 set in advance. The voltage Ramp2 of the edge delay circuit 130 may start rising again at the time t4.

At the time t5, the voltage Ramp2 may become higher than the threshold voltage Vth2, and the capacitor Ct provided in the ramp voltage generation circuit 140 may start being charged with the feedback current Ifb. Further, the ramp voltage Vct of the ramp voltage generation circuit 140 may start rising again at the time t5. At the time t6, the ramp voltage Vct may become higher than the reference voltage Vp determined in advance, and the high side driving signal VgsH may turn Low to control the high side switch QH to turn off.

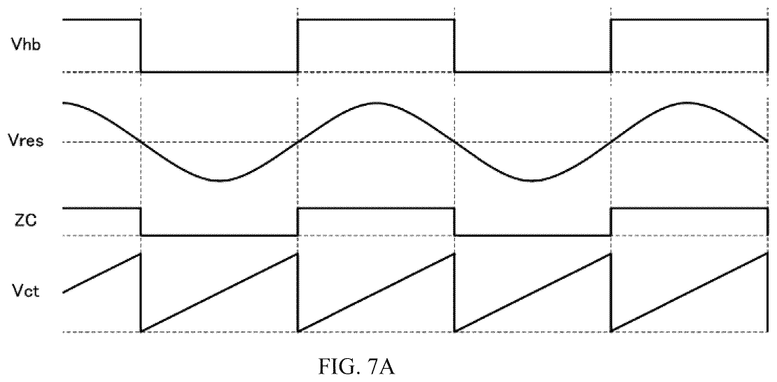

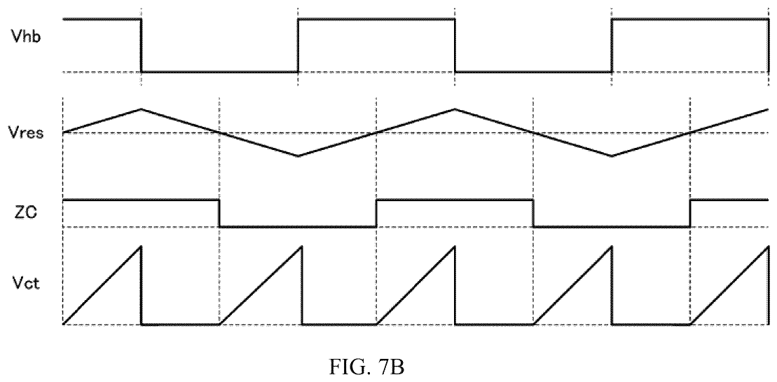

FIGS. 7A and 7B illustrate waveforms representing operations of the comparative example of FIG. 2 at rated load and at no load, respectively. More specifically, FIGS. 7A and 7B illustrate waveforms of a half bridge voltage Vhb, the voltage Vres, the zero cross signal ZC, and the ramp voltage Vct of a sawtooth waveform generated by the feedback current Ifb, at a maximum output current of the rated load and at no load, respectively.

Referring to FIG. 7A, a phase difference caused between the half bridge voltage Vhb and the zero cross signal ZC by a load current in the LLC converter 10 may be 0° at the maximum output current, that is, the half bridge voltage Vhb and the zero cross signal ZC may have no phase difference under such a condition.

In contrast, referring to FIG. 7B, the half bridge voltage Vhb and the zero cross signal ZC may have a 90° phase difference at no load in the LLC converter 10, and the zero cross signal ZC may lag behind the half bridge voltage Vhb.

Thus, according to an existing technique illustrated as the comparative example, the slope of the sawtooth waveform of the ramp voltage Vct for generating the driving signals may exhibit a maximum of a twofold change, as illustrated in FIGS. 7A and 7B. Accordingly, the feedback current Ifb may also exhibit a maximum of a twofold change.

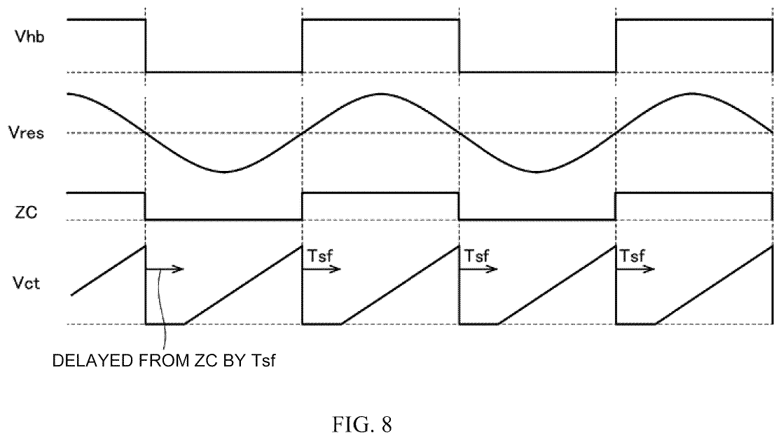

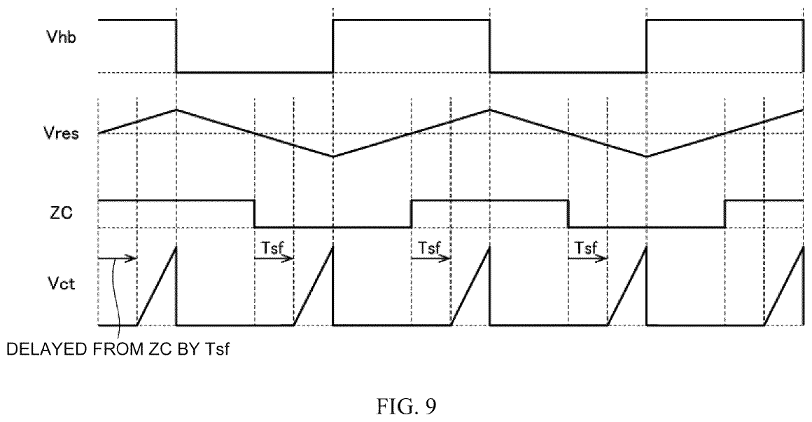

Next, a description will be given of operations of the LLC converter control circuit 100a according to the first example embodiment. FIGS. 8 and 9 illustrate waveforms representing the operations of the LLC converter control circuit 100a according to the first example embodiment at the maximum output current and at no load, respectively.

As illustrated in FIG. 7A described above, the half bridge voltage Vhb and the zero cross signal ZC may have a 0° phase difference at the maximum output current. Thus, according to the existing technique illustrated as the comparative example, the ramp voltage Vct of the sawtooth waveform resulting from the feedback current Ifb may be generated at times of inversion of the zero cross signal ZC, as illustrated in FIG. 7A. Accordingly, the feedback current Ifb may be given as ½×Ifb0, where Ifb0 represents the feedback current at no load.

In contrast, in the LLC converter control circuit 100a according to the first example embodiment, as indicated in the operation waveform in FIG. 8, the ramp voltage Vct of the sawtooth waveform resulting from the feedback current Ifb may be generated after a lapse of the time Tsf from each of the times of inversion of the zero cross signal ZC.

For example, as compared with a case of the existing technique illustrated in FIG. 7A, the slope of the sawtooth waveform of the ramp voltage Vct may increase by an amount corresponding to the delay. Given that the time Tsf is equal to Tsw/8 where Tsw represents an operation period, the slope of the sawtooth waveform may be 4/3 times that obtained with the existing technique. Accordingly, the feedback current Ifb may be given as ⅔×Ifb0.

At no load, as illustrated in FIG. 9, the half bridge voltage Vhb and the zero cross signal ZC may have a 90° phase difference. According to the existing technique illustrated in FIG. 7B, the ramp voltage Vct of the sawtooth waveform resulting from the feedback current Ifb may be generated at the times of inversion of the zero cross signal ZC, as illustrated in FIG. 7B.

In contrast, in the LLC converter control circuit 100a according to the first example embodiment, as indicated in the operation waveform in FIG. 9, the ramp voltage Vct of the sawtooth waveform resulting from the feedback current Ifb may be generated after the lapse of the time Tsf from each of the times of inversion of the zero cross signal ZC.

Thus, in the LLC converter control circuit 100a according to the first example embodiment, the slope of the sawtooth waveform of the ramp voltage Vct may increase by the amount corresponding to the delay, as compared with the case of the existing technique illustrated in FIG. 7B. For example, given that the time Tsf is equal to Tsw/8 where Tsw represents the operation period, the slope of the sawtooth waveform may be twice that obtained with the existing technique. Accordingly, the feedback current Ifb at no load in the LLC converter control circuit 100a according to the first example embodiment may be given as 2×Ifb0, where Ifb0 represents the feedback current at no load obtained with the existing technique.

Thus, according to the existing technique, as illustrated in FIGS. 7A and 7B, the feedback current Ifb may exhibit a twofold change between a no load condition and a maximum load condition, whereas in the LLC converter control circuit 100a according to the first example embodiment, the feedback current Ifb may exhibit a threefold change between the no load condition and the maximum load condition.

Further, with the configuration of the first example embodiment, increasing the time Tsf to be closer to ¼Tsw allows for a greater amount of change in the feedback current Ifb at light load to no load. This helps to accurately detect light load to no load conditions.

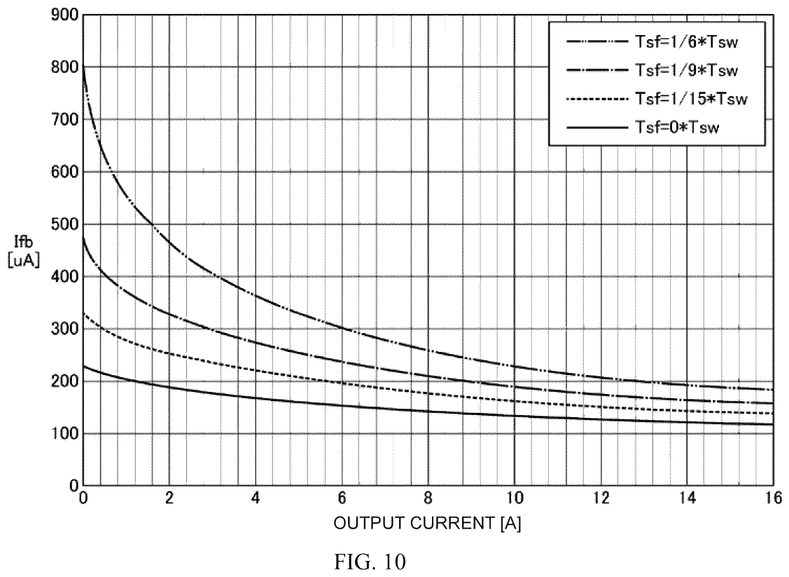

FIG. 10 is a graph illustrating a relationship between an output current Io and the feedback current Ifb in the LLC converter 10 according to the first example embodiment. More specifically, FIG. 10 illustrates a result of determining changes in the feedback current Ifb in relation to the output current Io by simulation.

Tsf being equal to 0×Tsw (where Tsw represents the operation period) indicates that there is no delay of the ramp voltage Vct of the sawtooth waveform from the zero cross signal ZC. Thus, a curve for “Tsf=0×Tsw” in FIG. 10 represents a characteristic obtainable with the existing control method.

As illustrated in FIG. 10, increasing the time Tsf increased the feedback current Ifb at light load. Further, as the time Tsf increased, the changes in the feedback current Ifb in relation to the output current Io increased, resulting in a steeper slope, at no load to light load. This indicates that the LLC converter control circuit 100a according to the first example embodiment helps to accurately detect a light load condition, based on the feedback current Ifb.

### Second Example Embodiment

One example embodiment has been described above. The foregoing example embodiment is merely exemplary and non-limiting. For example, in the foregoing example embodiment, an example case has been described where the time Tsf is defined by a predetermined threshold. In some embodiments, however, the time Tsf may be finely adjustable. A description will now be given of an LLC converter control circuit 100b according to a second example embodiment that allows for such fine adjustments of the time Tsf. The description will focus on a configuration different from that in the first example embodiment.

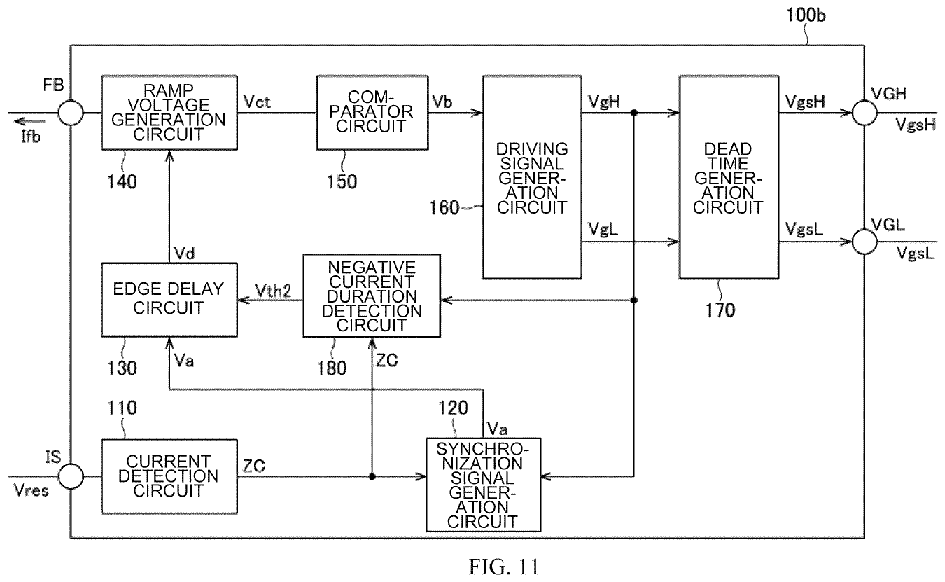

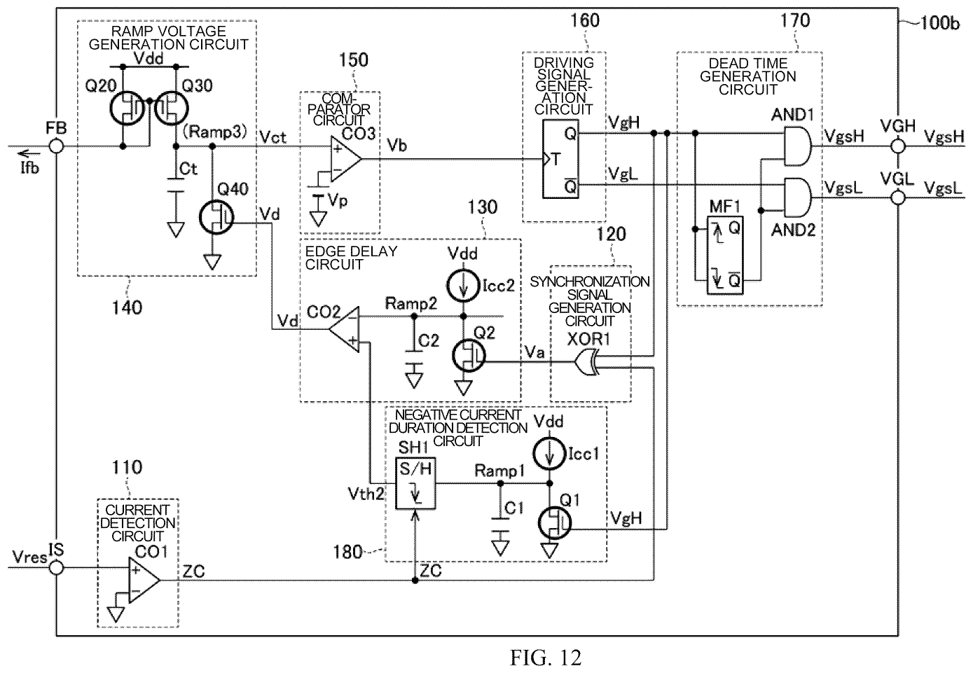

FIGS. 11 and 12 are diagrams illustrating the configuration of the LLC converter control circuit 100b according to the second example embodiment. As illustrated in FIGS. 11 and 12, the LLC converter control circuit 100b according to the second example embodiment may be different from the LLC converter control circuit 100a according to the first example embodiment in further including a negative current duration detection circuit 180. The negative current duration detection circuit 180 may correspond to a specific but non-limiting example of a “negative current duration detection circuit”according to one or more embodiments.

As described above, in the LLC converter control circuit 100a according to the first example embodiment, the edge delay circuit 130 may generate the delay signal Vd, based on the threshold voltage Vth2 determined in advance. In contrast, in the LLC converter control circuit 100b according to the second example embodiment, the negative current duration detection circuit 180 may generate the threshold voltage Vth2. The threshold voltage Vth2 may correspond to a specific but non-limiting example of a “threshold voltage”according to one or more embodiments.

Based on the first driving signal VgH of the driving signal generation circuit 160 and the zero cross signal ZC generated at the current detection circuit 110, the negative current duration detection circuit 180 may measure a duration over which a negative current flows through the high side switch QH or the low side switch QL after switching of the high side switch QH and the low side switch QL. The negative current duration detection circuit 180 may generate and output the threshold voltage Vth2 that corresponds to such a duration of the negative current. For example, the negative current duration detection circuit 180 may generate the threshold voltage Vth2 that corresponds to a time Tn elapsing from a moment at which the first driving signal VgH turns Low to a moment at which the zero cross signal ZC turns Low.

Further, the edge delay circuit 130 may delay a falling edge of the first signal Va by a time Ts corresponding to a time elapsing before the voltage charged in the capacitor C2 reaches the threshold voltage Vth2. In an example illustrated in FIG. 12, given that K=Ts/Tn, the threshold voltage Vth2 may be given as follows: Vth2=Icc1×Tn/C1. Further, because Ts may be equal to C2×Vth2/Icc2, K may be given as follows: K=(Icc1/Icc2)×(C2/C1).

The LLC converter control circuit 100b according to the second example embodiment may set values of a current Icc1 and a capacitor C1 and values of the current Icc2 and the capacitor C2 with K within a range greater than 0 and less than 1, and may delay the falling edge of the first signal Va by the time Ts proportional to the time Tn.

For example, when K is to be set to 0.5, the desired value of K may be achieved by satisfying: Icc1=Icc2 and C1=2×C2; or C1=C2 and Icc2=2×Icc1.

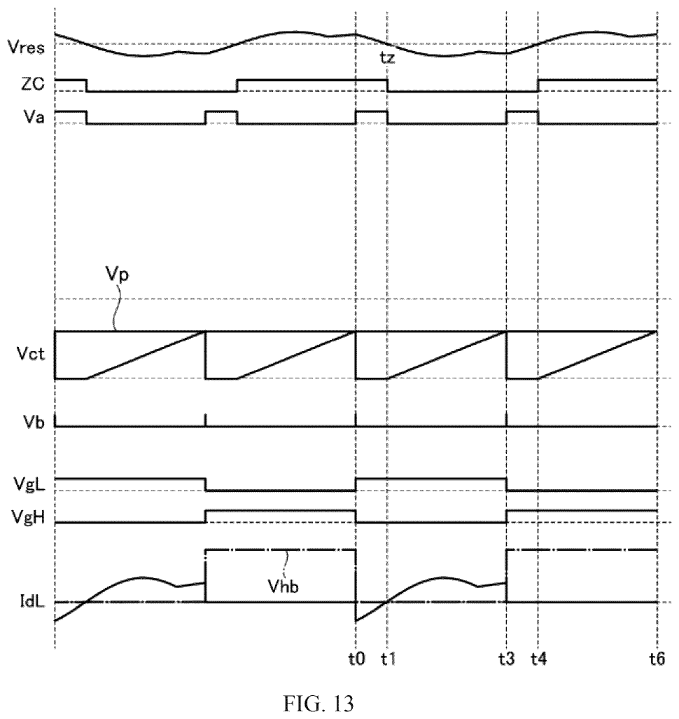

FIG. 13 is a diagram for describing an example operation obtainable with the existing circuit configuration of the LLC converter control circuit illustrated in FIG. 2 as the comparative example.

The current detection circuit 110 may perform a comparison between the voltage Vres at the IS terminal and the GND potential, and send out the zero cross signal ZC. At the time t0, the ramp voltage Vct at the capacitor Ct may become higher than the reference voltage Vp determined in advance, the second signal Vb may turn High, the first driving signal VgH may turn Low, and the second driving signal VgL may turn High. Further, the first signal Va may turn High, a transistor Q40 of the ramp voltage generation circuit 140 may turn on, the ramp voltage Vct may drop to zero, and the second signal Vb may turn Low.

Thereafter, at the time t1, the zero cross signal ZC outputted from the current detection circuit 110 may turn Low from High. Further, the first signal Va may turn Low and the transistor Q40 may turn off. Further, the ramp voltage generation circuit 140 may start charging the capacitor Ct with the feedback current Ifb. Furthermore, the ramp voltage Vct may start rising at the time t1.

At the time t3, the ramp voltage Vct at the capacitor Ct may become higher than the reference voltage Vp determined in advance, the second signal Vb may turn High, the second driving signal VgL may turn Low, and the first driving signal VgH may turn High.

At the time t4, the zero cross signal ZC outputted from the current detection circuit 110 may turn High from Low. Further, the first signal Va may turn Low and the transistor Q40 may turn off. Further, the capacitor Ct may start being charged with the feedback current Ifb. The ramp voltage Vct may start rising at the time t4.

At the time t6, the ramp voltage Vct at the capacitor Ct may become higher than the reference voltage Vp determined in advance, the second signal Vb may turn High, the first driving signal VgH may turn Low, and the second driving signal VgL may turn High. Further, the first signal Va may turn High, the transistor Q40 may turn on, the ramp voltage Vct may drop to zero, and the second signal Vb may turn Low.

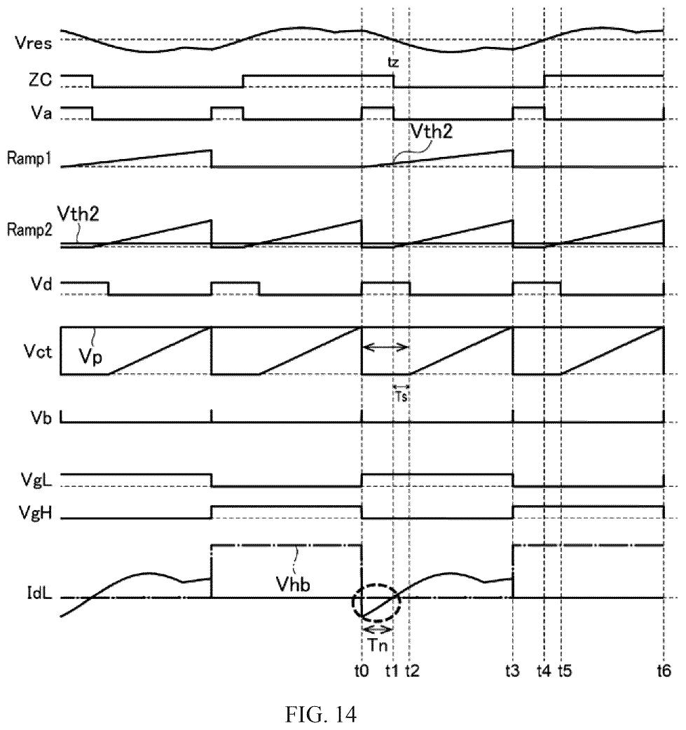

FIG. 14 is a waveform diagram illustrating an operation of the LLC converter control circuit 100b according to the second example embodiment. The current detection circuit 110 may perform a comparison between the voltage Vres at the IS terminal and the GND potential, and send out the zero cross signal ZC.

At the time t0, the second signal Vb may turn High, the first driving signal VgH may turn Low, and the second driving signal VgL may turn High. Further, in the negative current duration detection circuit 180, a transistor Q1 may turn off, the capacitor C1 may start being charged with the current Icc1, and a voltage Ramp1 may start rising at the time t0.

Further, at the time t0, the first signal Va may turn High and a transistor Q2 may turn on. The voltage Ramp2 may drop to zero. Furthermore, the delay signal Vd may turn High and the transistor Q40 of the ramp voltage generation circuit 140 may turn on. Further, the ramp voltage Vct may drop to zero and the second signal Vb may turn Low.

At the time t1, the zero cross signal ZC of the current detection circuit 110 may turn Low from High. Further, at the time t1, a sample-and-hold circuit SH1 may sample and hold the voltage Ramp1 at a negative edge of the zero cross signal ZC to generate the threshold voltage Vth2.

The threshold voltage Vth2 may be a voltage proportional to the time Tn over which a current IdL is a negative current. The first signal Va may turn Low and the transistor Q2 may turn off. The edge delay circuit 130 may thus start charging the capacitor C2 with the current Icc2 set in advance. The voltage Ramp2 may start rising at the time t1.

At the time t2, the voltage Ramp2 may reach the threshold voltage Vth2. Further, the delay signal Vd may turn Low, the transistor Q40 may turn off, and the capacitor Ct may start being charged with the feedback current Ifb. Furthermore, the ramp voltage Vct may start rising at the time t2.

Here, the time Ts may be proportional to the time Tn, having a relationship expressed as follows: Tn:Ts=C1/Icc1:C2/Icc2.

At the time t3, the ramp voltage Vct, i.e., the voltage at the capacitor Ct may become higher than the reference voltage Vp determined in advance, the second signal Vb may turn High, the second driving signal VgL may turn Low, and the first driving signal VgH may turn High. Further, the first signal Va may turn High and the transistor Q2 may turn on. Furthermore, the voltage Ramp2 may drop to zero. Further, the delay signal Vd may turn High and the transistor Q40 may turn on. Furthermore, the ramp voltage Vct may drop to zero and the second signal Vb may turn Low.

At the time t4, the zero cross signal ZC of the current detection circuit 110 may turn High from Low, the first signal Va may turn Low, and the transistor Q2 may turn off. Further, the edge delay circuit 130 may start charging the capacitor C2 with the current Icc2 set in advance. The voltage Ramp2 may start rising at the time t4.

At the time t5, the voltage Ramp2 may reach the threshold voltage Vth2. The delay signal Vd may turn Low, the transistor Q40 may turn off, and the capacitor Ct may start being charged with the feedback current Ifb. Further, the ramp voltage Vct may start rising at the time t5.

Further, as described above, the time Ts may be proportional to the time Tn, having the relationship expressed as follows: Tn: Ts=C1/Icc1:C2/Icc2.

At the time t6, the second signal Vb may turn High, the first driving signal VgH may turn Low, and the second driving signal VgL may turn High. Further, the transistor Q1 may turn off, the capacitor C1 may start being charged with the current Icc1, and the voltage Ramp1 may start rising at the time t6.

Further, the first signal Va may turn High and the transistor Q2 may turn on. Further, the voltage Ramp2 may drop to zero. Furthermore, the delay signal Vd may turn High and the transistor Q40 may turn on. The ramp voltage Vct may drop to zero and the second signal Vb may turn Low.

As described in relation to the foregoing first example embodiment, FIGS. 7A and 7B are diagrams for describing the sawtooth waveforms of the ramp voltage Vct obtainable according to the existing technique when the output current Io is maximum and when the output current Io is zero, respectively.

As illustrated in FIG. 7A, the half bridge voltage Vhb and the current flowing through the resonant circuit Re coupled to the half bridge circuit Hb may have a 0° phase difference at the maximum output current. Accordingly, at the maximum output current, the voltage Vres may cross zero upon switching of the high side switch QH and the low side switch QL in the half bridge circuit Hb, and the ramp voltage Vct of the ramp voltage generation circuit 140 may thus rise upon switching of the high side switch QH and the low side switch QL.

As illustrated in FIG. 7B, the half bridge voltage Vhb and the current flowing through the resonant circuit Re coupled to the half bridge circuit Hb may have a 90° phase difference at no load, i.e., when the output current Io is zero. Accordingly, at no load, the voltage Vres may cross zero at a point in time between times of switching of the high side switch QH and the low side switch QL in the half bridge circuit Hb. The ramp voltage Vct of the ramp voltage generation circuit 140 may rise after a delay of one half of an on-period of the high side switch QH or the low side switch QL from each of the times of switching of the high side switch QH and the low side switch QL.

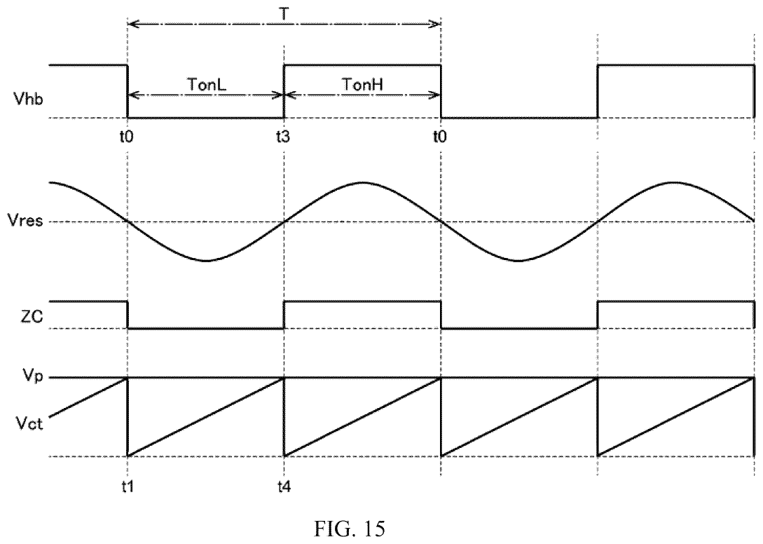

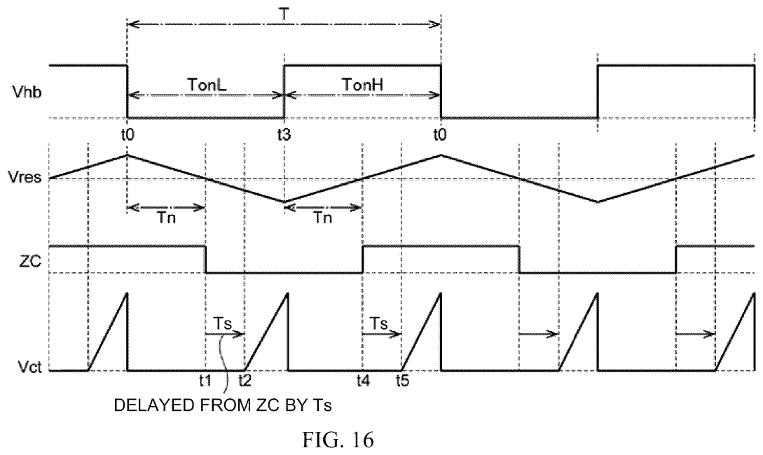

FIGS. 15 and 16 are diagrams for describing the sawtooth waveforms of the ramp voltage Vct when the output current Io is maximum and when the output current Io is zero, respectively, in the LLC converter control circuit 100b according to the second example embodiment.

As illustrated in FIG. 15, the half bridge voltage Vhb and the current flowing through the resonant circuit Re coupled to the half bridge circuit Hb may have a 0° phase difference at the maximum output current. Accordingly, at the maximum output current, the voltage Vres may cross zero upon switching of the high side switch QH and the low side switch QL in the half bridge circuit Hb, which results in no duration over which a negative current flows after switching of the high side switch QH and the low side switch QL. The ramp voltage Vct of the ramp voltage generation circuit 140 may thus rise upon switching of the high side switch QH and the low side switch QL.

In contrast, as illustrated in FIG. 16, the half bridge voltage Vhb and the current flowing through the resonant circuit Re coupled to the half bridge circuit Hb may have a 90° phase difference at no load. Accordingly, at no load, a negative current may flow through the low side switch QL over the time Tn that elapses from the time t0 at which the high side switch QH turns off and the low side switch QL turns on to the time t1. In the LLC converter control circuit 100b according to the second example embodiment, the ramp voltage Vct of the ramp voltage generation circuit 140 may rise at the time t2 at which the time Ts proportional to the time Tn has elapsed from the time t1.

For example, in an operation waveform where Ts is set to 0.5×Tn, as illustrated in FIG. 16, the ramp voltage Vct may rise after a delay of one quarter of a time TonL from the zero cross signal ZC. This may cause the slope of the sawtooth waveform to be twice that obtainable with the existing technique illustrated in FIG. 7B. Thus, the slope of the sawtooth waveform may exhibit a maximum of a fourfold change, and the feedback current Ifb may also exhibit a maximum of a fourfold change.

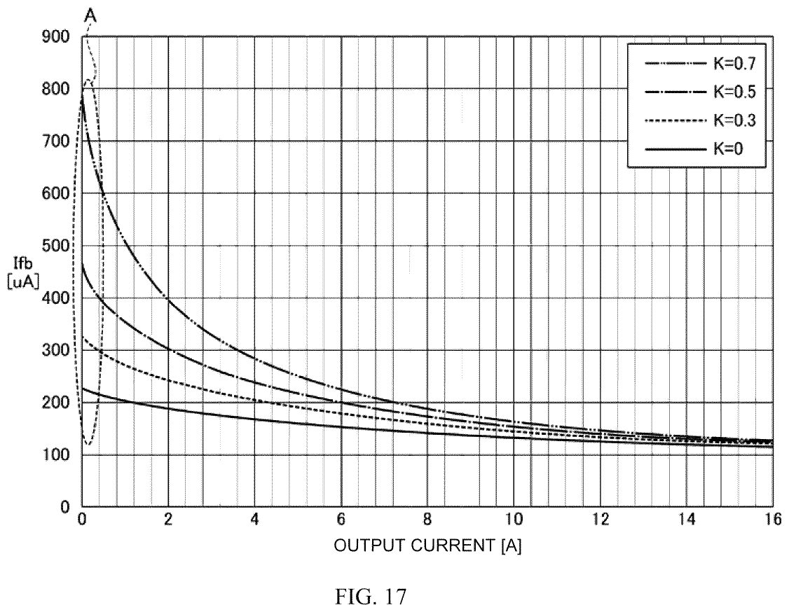

FIG. 17 is a graph illustrating a relationship between the output current Io and the feedback current Ifb in the LLC converter 10 according to the second example embodiment. Characteristics illustrated in FIG. 17 are results of determining changes in the feedback current Ifb in relation to the output current Io by simulation on the LLC converter control circuit 100b according to the second example embodiment. Here, K=Ts/Tn. K being zero, i.e., Ts/Tn being zero indicates no delay of the ramp voltage Vct. A solid curve for “K=0” thus represents a characteristic obtainable with the existing control method.

FIG. 17 indicates that increasing the value K increased the feedback current Ifb at light load. Further, at no load to extremely light load, that is, in a region labeled “A” in the graph, the changes in the feedback current Ifb in relation to the output current Io increased to exhibit a steeper slope.

Thus, in the LLC converter control circuit 100b according to the second example embodiment, the amount of change in the feedback current Ifb with respect to the output current Io increased, that is, became steeper in slope, at extremely light load. This indicates that the LLC converter control circuit 100b according to the second example embodiment helps to accurately detect an extremely light load condition, based on the feedback current Ifb.

### Third Example Embodiment

Next, a third example embodiment will be described. Note that in the following description, the same reference signs as those in the first example embodiment and/or the second example embodiment denote the same configurations as those in the first example embodiment and/or the second example embodiment, and reference will be made to preceding descriptions regarding the relevant components or configurations unless otherwise specified. Here, descriptions will be given of the LLC converter control circuits 100c to 100e according to the third example embodiment, with attention focused on configurations different from those in the first example embodiment and/or the second example embodiment. The LLC converter control circuits 100c to 100e may each generate a proportional voltage proportional to a switching period of the resonant circuit Re.

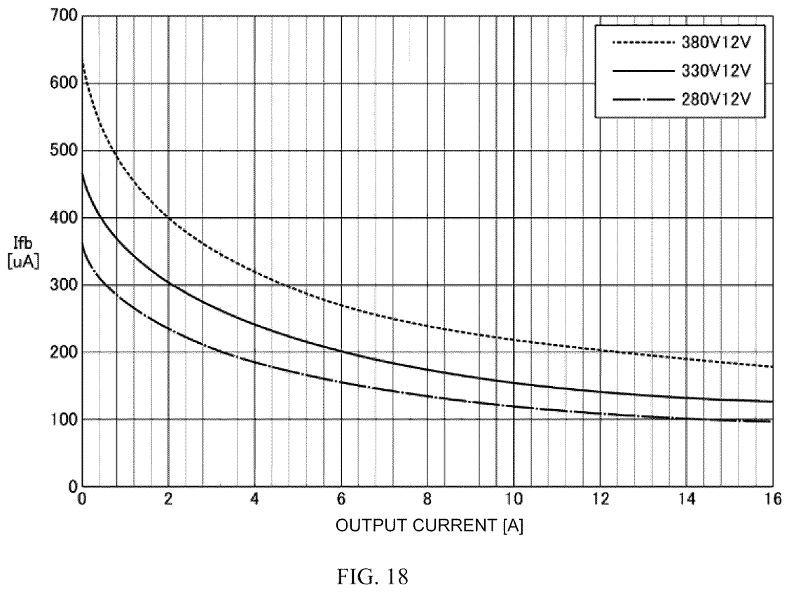

FIG. 18 illustrates a simulation result on the changes in the feedback current Ifb in relation to the output current Io where K=0.5 in the LLC converter control circuit 100b according to the foregoing second example embodiment, obtained with varying input voltage.

The LLC converter 10 may greatly vary in frequency depending on the input voltage, and a variation range of the feedback current Ifb in relation to the output current Io may therefore vary depending on the input voltage. This can make it difficult for the LLC converter 10 with varying input voltage to detect a light load condition, based on only the feedback current Ifb.

The LLC converter control circuit 100c according to the third example embodiment helps to suppress the variations in the feedback current Ifb dependent on the input voltage, by employing a proportional voltage Vpp proportional to a period of the first driving signal VgH or the second driving signal VgL as a voltage to be compared with the ramp voltage Vct. This helps to allow the LLC converter control circuit 100c according to the third example embodiment to accurately detect a light load condition, regardless of the input voltage.

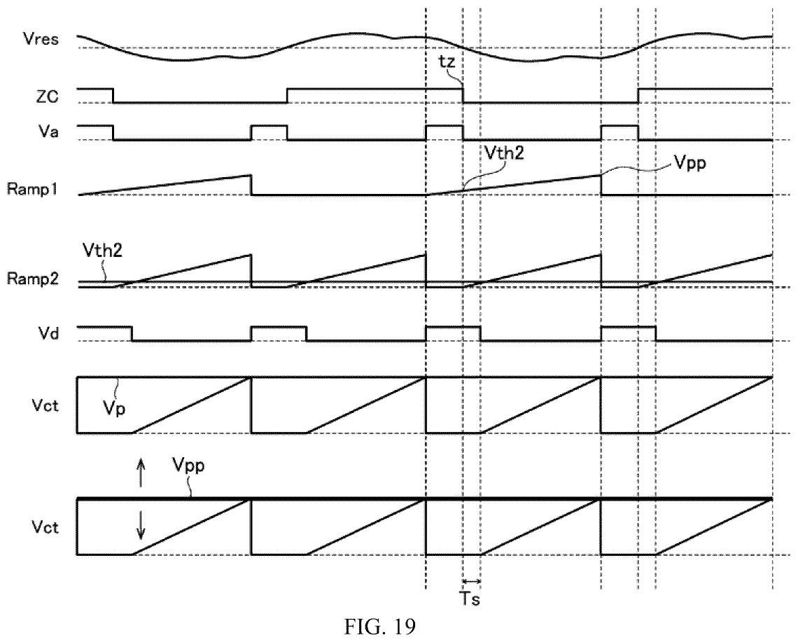

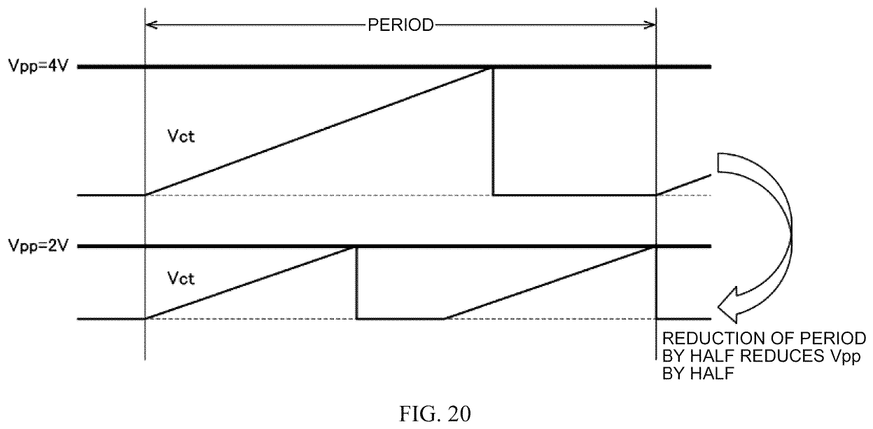

FIGS. 19 and 20 are diagrams for describing the proportional voltage Vpp of the LLC converter control circuit 100c according to the third example embodiment. As illustrated in FIG. 19, the LLC converter control circuit 100c according to the third example embodiment may generate the proportional voltage Vpp proportional to a time over which the first driving signal VgH of the driving signal generation circuit 160 is Low. Accordingly, the feedback current Ifb would not vary depending on an operation period or frequency, and would thus be unaffected by the input voltage.

For example, as illustrated in FIG. 20, the proportional voltage Vpp to be compared with the ramp voltage Vct at the comparator circuit 150 may be variable up and down depending on the operation period. In other words, the proportional voltage Vpp may be proportional to the period of the first driving signal VgH or the second driving signal VgL, and may therefore increase as the period becomes longer and decrease as the period becomes shorter. This helps to allow the slope of the ramp voltage Vct, which corresponds to the value of the feedback current Ifb, to be the same regardless of whether the period becomes longer or shorter. The LLC converter control circuit 100c according to the third example embodiment thus helps to allow the feedback current Ifb to have a constant value.

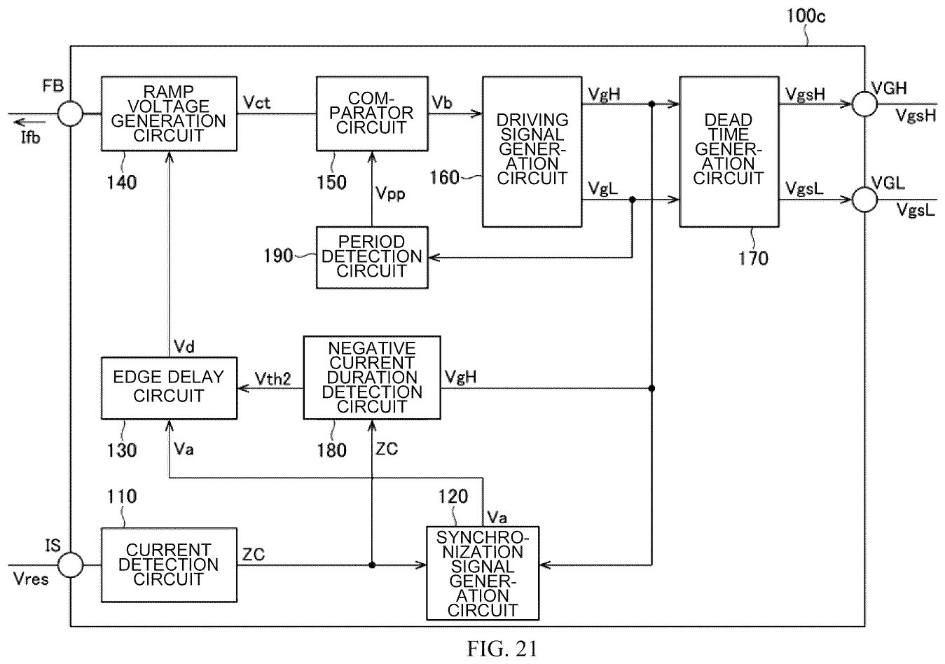

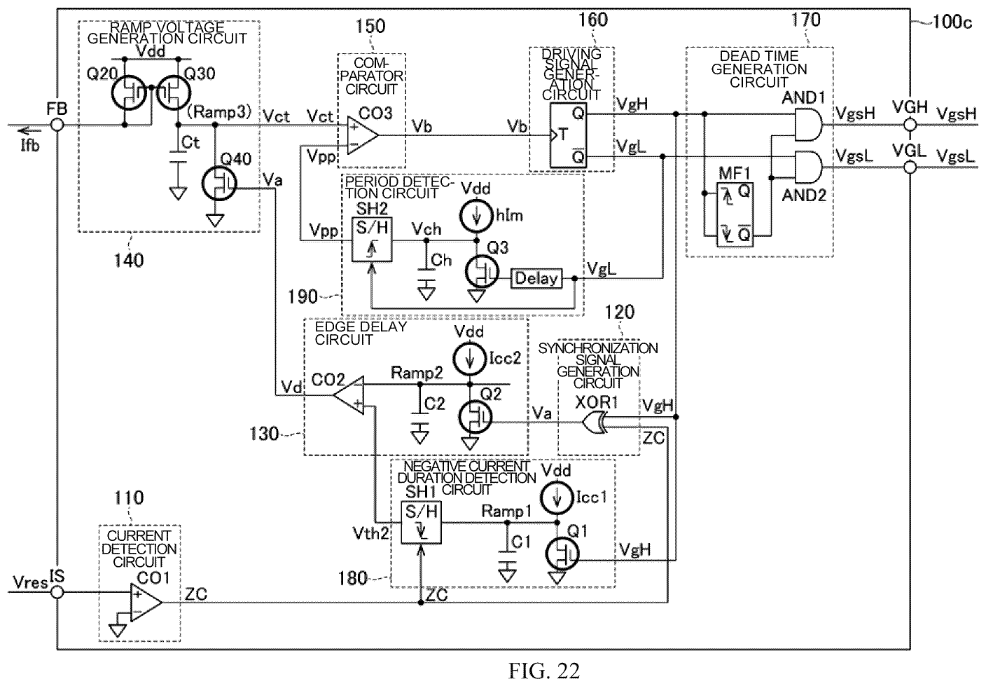

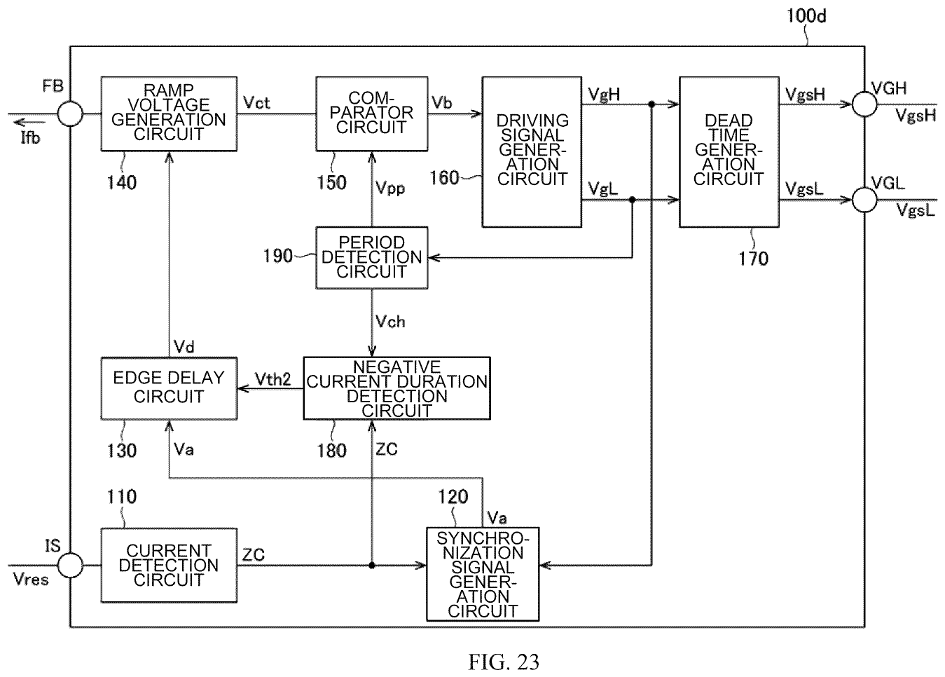

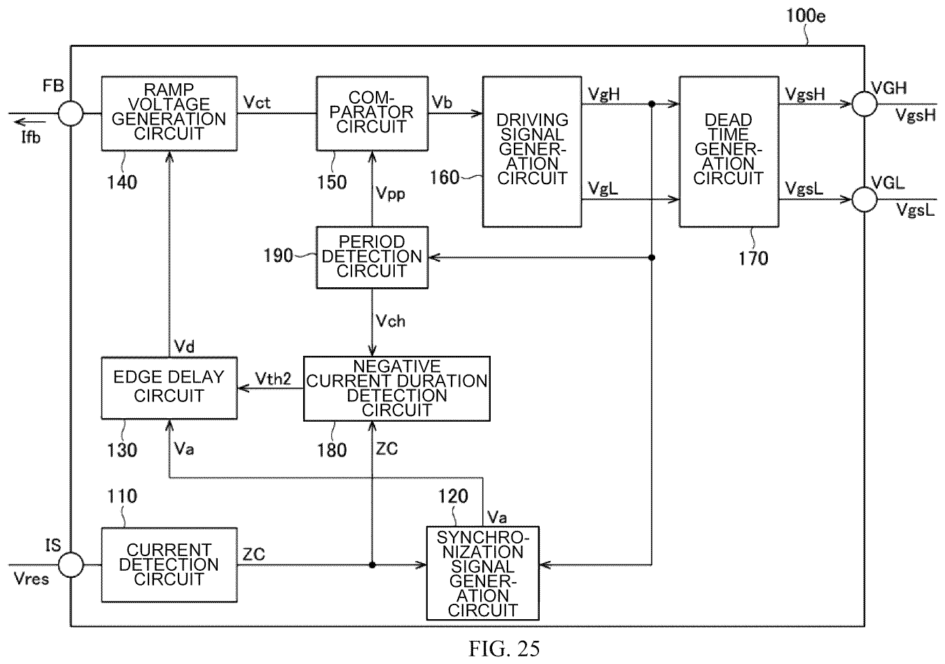

FIGS. 21 and 22 are diagrams illustrating a configuration of the LLC converter control circuit 100c according to the third example embodiment. FIGS. 23 to 26 are diagrams illustrating configurations of the LLC converter control circuits 100d and 100e as other configuration examples according to the third example embodiment.

The LLC converter control circuits 100c, 100d, and 100e according to the third example embodiment may each be different from the LLC converter control circuit 100b according to the foregoing second example embodiment in further including a period detection circuit 190.

The period detection circuit 190 may correspond to a specific but non-limiting example of a “period detection circuit”according to one or more embodiments.

As with the negative current duration detection circuit 180 described above, the period detection circuit 190 may include a sample-and-hold circuit SH2 and may generate the proportional voltage Vpp proportional to the period of the first driving signal VgH or the second driving signal VgL. For example, in an example illustrated in FIG. 22, the sample-and-hold circuit SH2 may sample and hold a voltage Vch at a positive edge of the second driving signal VgL to generate the proportional voltage Vpp.

In the example illustrated in FIG. 22, the period detection circuit 190 may delay a rising edge of the second driving signal VgL at a “Delay” circuit, discharge the voltage Vch at the delayed rising edge of the second driving signal VgL, and sample the voltage Vch at the pre-delayed rising edge of the second driving signal VgL to generate the proportional voltage Vpp proportional to the period of the second driving signal VgL.

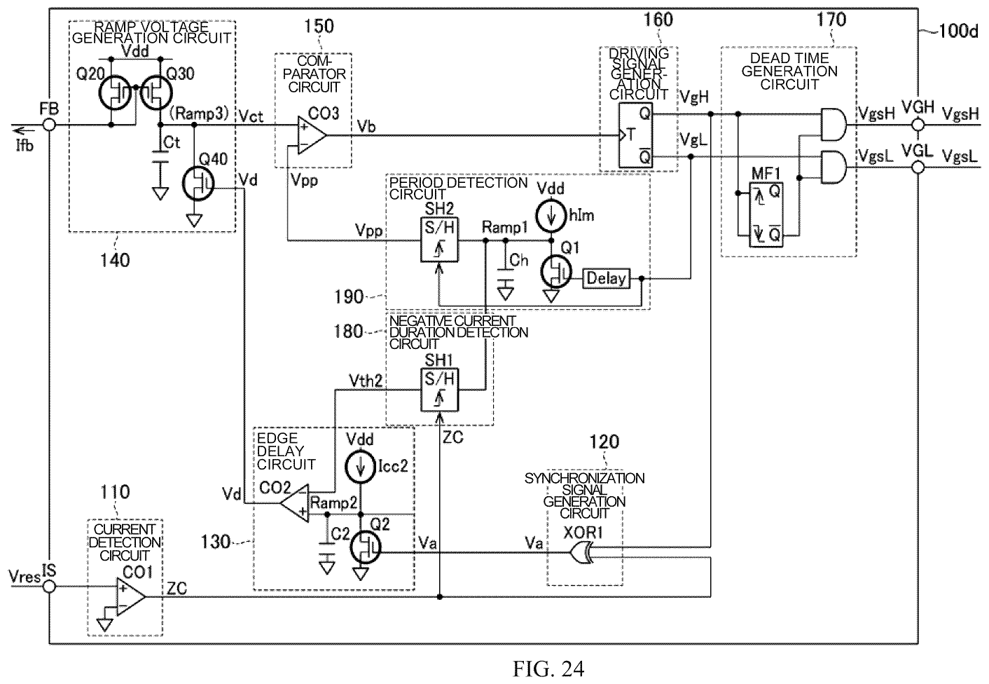

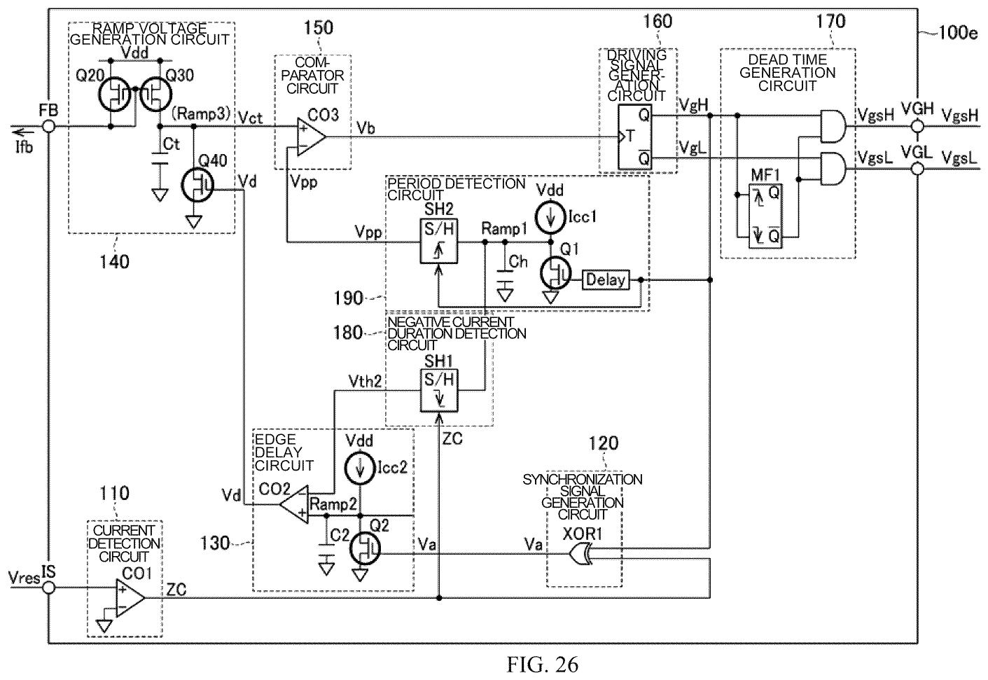

The LLC converter control circuit 100d illustrated in FIG. 24 and the LLC converter control circuit 100e illustrated in FIG. 26 may each be so configured that the voltage Ramp1 charged at the period detection circuit 190 serves as a voltage to be sampled and held at the negative current duration detection circuit 180.

In some embodiments, as illustrated in FIG. 26, the period detection circuit 190 may delay a rising edge of the first driving signal VgH at the “Delay” circuit, discharge the voltage Vch at the delayed rising edge of the first driving signal VgH, and sample the voltage Vch at the pre-delayed rising edge of the first driving signal VgH to generate the proportional voltage Vpp proportional to the period of the first driving signal VgH.

Such a configuration allows the negative current duration detection circuit 180 and the period detection circuit 190 to share some components with each other in each of the LLC converter control circuits 100d and 100e according to the third example embodiment. This helps to achieve reduction in circuit scale.

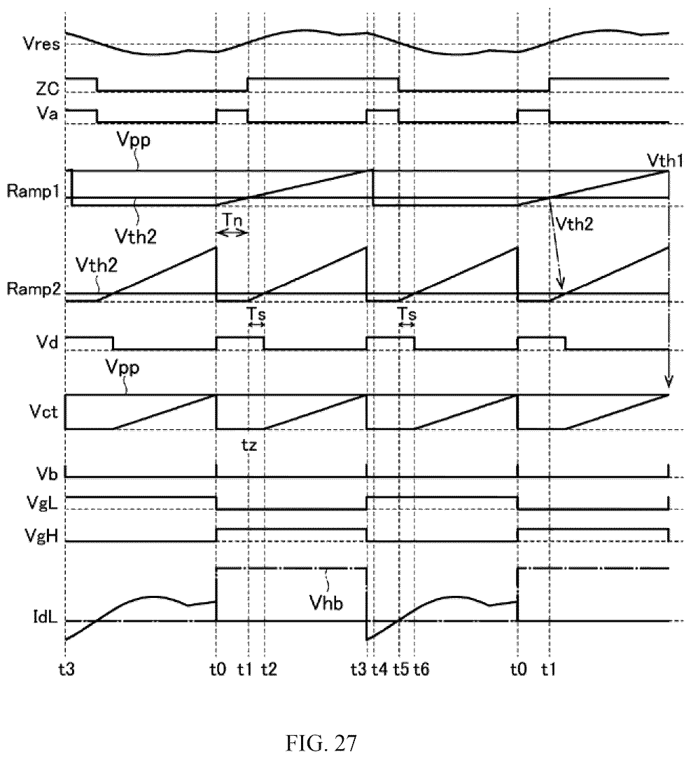

FIG. 27 is a waveform diagram for describing an operation of the LLC converter control circuit 100d according to the third example embodiment.

At the time t0, the ramp voltage Vct of the ramp voltage generation circuit 140 may exceed the proportional voltage Vpp, and accordingly, the second signal Vb as an output of the comparator circuit 150 may turn High. This may cause the second driving signal VgL of the driving signal generation circuit 160 to turn Low and cause the first driving signal VgH of the driving signal generation circuit 160 to turn High.

The comparator circuit 150 may correspond to a specific but non-limiting example of a “comparator circuit”according to one or more embodiments.

Due to the zero cross signal ZC of the current detection circuit 110 being Low, the first signal Va may turn High. At the ramp voltage generation circuit 140, the transistor Q40 may turn on and the capacitor Ct may be discharged. At the comparator circuit 150, the ramp voltage Vct may become less than or equal to the proportional voltage Vpp, and the second signal Vb may turn Low.

In addition, in response to the second driving signal VgL turning Low, the transistor Q1 of the period detection circuit 190 may turn off and the voltage Ramp1 may start rising.

At the time t1, the voltage Vres may turn positive, and accordingly, the zero cross signal ZC outputted from the current detection circuit 110 may turn High. Further, the first signal Va as an output of the synchronization signal generation circuit 120 may turn Low. This may turn off the transistor Q2 of the edge delay circuit 130 and cause the voltage Ramp2 to start rising.

When the first signal Va as the output of the synchronization signal generation circuit 120 turns Low, the negative current duration detection circuit 180 may sample and hold the voltage Ramp1 and output the threshold voltage Vth2.

At the time t2, the voltage Ramp2 of the edge delay circuit 130 may reach the threshold voltage Vth2 or higher, and accordingly, the delay signal Vd may turn Low. This may turn off the transistor Q40 of the ramp voltage generation circuit 140 and cause the ramp voltage Vct to start rising. Here, the ramp voltage Vct of a triangular waveform generated by the feedback current Ifb may rise after a delay of the time Ts from a zero-crossing time.

At the time t3, the ramp voltage Vct as an output of the ramp voltage generation circuit 140 may exceed the proportional voltage Vpp, and accordingly, the second signal Vb as the output of the comparator circuit 150 may turn High. This may cause the first driving signal VgH of the driving signal generation circuit 160 to turn Low and cause the second driving signal VgL of the driving signal generation circuit 160 to turn High.

Due to the zero cross signal ZC at the synchronization signal generation circuit 120 being High, the first signal Va may turn High. At the ramp voltage generation circuit 140, the transistor Q40 may turn on and the capacitor Ct may be discharged. At the comparator circuit 150, the ramp voltage Vct may become less than or equal to the proportional voltage Vpp, and the second signal Vb may turn Low.

At the time t4, based on the first driving signal VgH delayed by the “Delay” circuit of the period detection circuit 190 after having turned High, the transistor Q1 may turn on and the voltage Ramp1 may be discharged.

At the time t5, the voltage Vres may turn negative, and accordingly, the zero cross signal ZC outputted from the current detection circuit 110 may turn Low. Further, the first signal Va as the output of the synchronization signal generation circuit 120 may turn Low. Further, the transistor Q2 of the edge delay circuit 130 may turn off and the voltage Ramp2 may start rising.

At the time t6, the voltage Ramp2 of the edge delay circuit 130 may reach the threshold voltage Vth2 or higher, and accordingly, the delay signal Vd may turn Low. Further, the transistor Q40 of the ramp voltage generation circuit 140 may turn off and the ramp voltage Vct may start rising. The ramp voltage Vct of the triangular waveform generated by the feedback current Ifb may rise after a delay by the time Ts from the zero-crossing time.

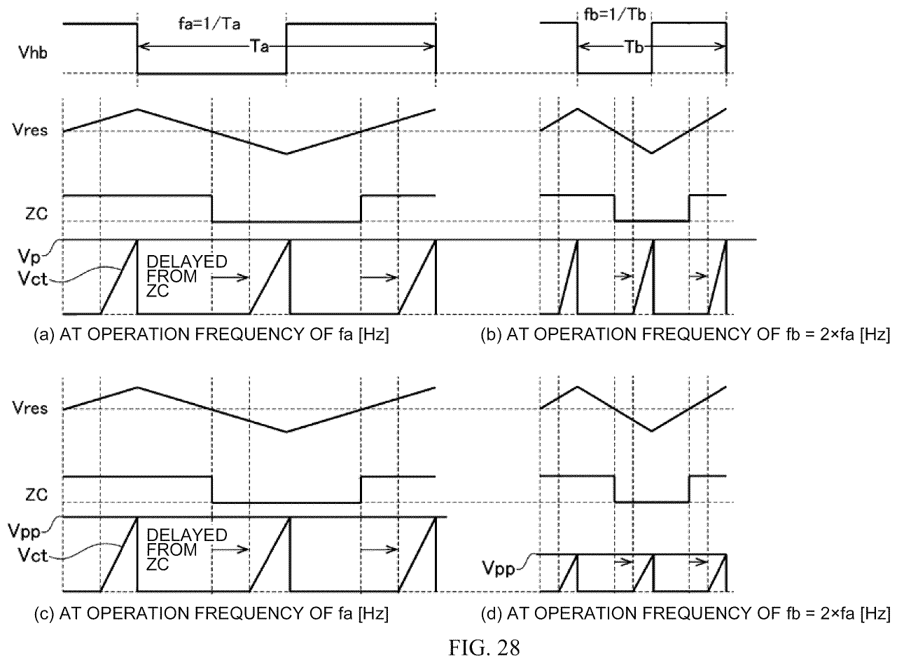

FIG. 28 is a diagram illustrating an example of comparison between operations of the LLC converter control circuits 100b and 100c according to the second and third example embodiments at no load. In FIG. 28, upper parts (a) and (b) illustrate operation waveforms of the LLC converter control circuit 100b according to the second example embodiment, and lower parts (c) and (d) illustrate operation waveforms of the LLC converter control circuit 100c according to the third example embodiment.

In the LLC converter control circuit 100b according to the second example embodiment, at an operation frequency of fa [Hz], as illustrated in part (a) of FIG. 28, the ramp voltage Vct of a sawtooth waveform and the reference voltage Vp determined in advance may be compared to determine turning-off timings of the high side switch QH and the low side switch QL.

When the input voltage becomes higher than that in a state of part (a) and the operation frequency reaches fb [Hz] that is twice higher than fa [Hz] as illustrated in part (b), the feedback current Ifb may have to be twice higher to allow the slope of the ramp voltage Vct to be twice greater. The same applies when the load current is high.

In contrast, in the LLC converter control circuit 100c according to the third example embodiment, a capability of generating the proportional voltage Vpp proportional to the period of the first driving signal VgH or the second driving signal VgL may be additionally provided to perform a comparison between the ramp volage Vct and the proportional voltage Vpp.

In the LLC converter control circuit 100c according to the third example embodiment, at the operation frequency of fa [Hz], as illustrated in part (c) of FIG. 28, the ramp voltage Vct of the sawtooth waveform and the proportional voltage Vpp generated may be compared to determine the turning-off timings of the high side switch QH and the low side switch QL. As illustrated in part (d), when the input voltage increases and the operation frequency reaches fb [Hz] that is twice higher than fa [Hz], the period may be reduced by half. Accordingly, as illustrated in part (d), the proportional voltage Vpp to be generated may drop by half, with the slope of the ramp voltage Vct unchanged. Thus, at no load, the feedback current Ifb is allowed to remain the same, regardless of the operation frequency.

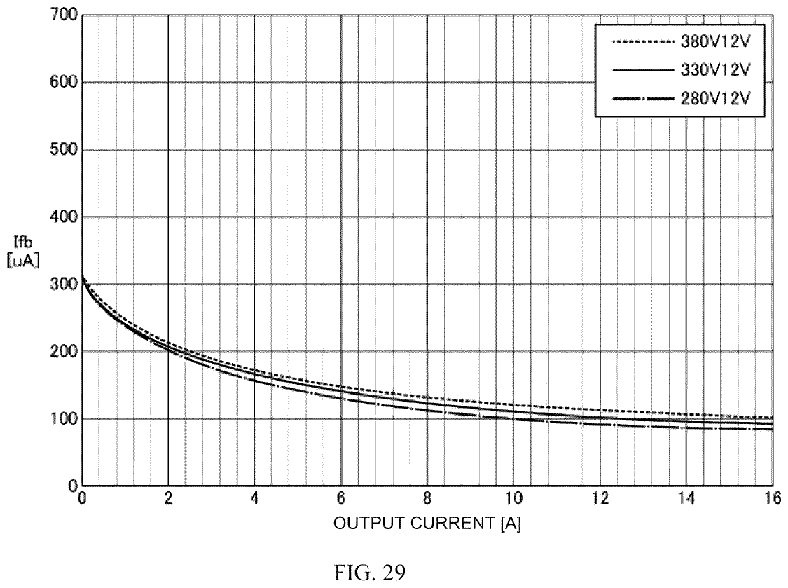

Next, a description will be given of a relationship between the output current Io and the feedback current Ifb in the LLC converter control circuit 100 according to the third example embodiment. As described in relation to the second example embodiment above, FIG. 18 illustrates the relationship between the output current Io and the feedback current Ifb where K=0.5 in the LLC converter control circuit 100b according to the second example embodiment illustrated in FIG. 12. FIG. 29 illustrates the relationship between the output current Io and the feedback current Ifb where K=0.5 in each of the LLC converter control circuits 100c, 100d, and 100e according to the third example embodiment.

FIG. 18 indicates that the feedback current Ifb varies depending on the input voltage. In contrast, a graph in FIG. 29 indicates reduction in variations of the feedback current Ifb depending on the input voltage, and also indicates narrowing of a variation width of the feedback current Ifb with decreasing output current Io. Thus, the LLC converter control circuits 100c, 100d, and 100e according to the third example embodiment each help to accurately detect a light load condition, regardless of the input voltage.

### Other Embodiments

Although one or more example embodiments of the disclosure have been described in detail with reference to the accompanying drawings, the disclosure is by no means limited by what is described in relation to such example embodiments above. Further, the components described hereinabove include those that may be readily conceived by a person skilled in the art and those that are substantially the same. Still further, any two or more of the configurations described hereinabove may be combined as appropriate. It is to be appreciated that various omissions, alterations, and modifications may be made to any of the configurations without departing from the gist of embodiments of the disclosure.

Features of the LLC converter control circuit 100 and the LLC converter 10 are described below.

The LLC converter control circuit 100 according to a first embodiment or embodiments is configured to control the high side driving signal VgsH and the low side driving signal VgsL, based on the resonant-current-converted voltage. The high side driving signal VgsH is adapted to drive the high side switch QH. The low side driving signal VgsL is adapted to drive the low side switch QL. The resonant-current-converted voltage corresponds to the voltage Vres. The voltage Vres is a voltage as a resultant of conversion from a current flowing through the resonant circuit Re configured to resonate through alternate turning-on and turning-off of the high side switch QH and the low side switch QL. The LLC converter control circuit 100 includes the current detection circuit 110. The current detection circuit 110 is configured to perform a comparison between the resonant-current-converted voltage and the GND potential and to output the zero cross signal ZC whose voltage level is to change at a timing at which the resonant-current-converted voltage switches to the positive potential or the negative potential. The LLC converter control circuit 100 further includes the synchronization signal generation circuit 120. The synchronization signal generation circuit 120 is configured to output the first signal Va indicating a value that is a resultant of an exclusive OR operation on respective values of the first driving signal VgH and the zero cross signal ZC. The first driving signal VgH is adapted to generate the high side driving signal VgsH. The LLC converter control circuit 100 further includes the edge delay circuit 130. The edge delay circuit 130 is configured to output the delay signal Vd. The delay signal Vd is the first signal Va delayed by a predetermined time. The LLC converter control circuit 100 further includes the ramp voltage generation circuit 140. The ramp voltage generation circuit 140 is configured to output the ramp voltage Vct by charging and discharging a current supplied from the feedback terminal FB into and from the capacitor Ct, based on a change in level of the delay signal Vd. The LLC converter control circuit 100 further includes the driving signal generation circuit 160. The driving signal generation circuit 160 is configured to generate, based on the ramp voltage Vct, the first driving signal VgH adapted to generate the high side driving signal VgsH and the second driving signal VgL adapted to generate the low side driving signal VgsL.

This configuration allows the amount of change in the feedback current Ifb to increase at near-zero load in the LLC converter control circuit 100. This helps to allow the LLC converter control circuit 100 to accurately determine an extremely light load condition, based on the amount of change in the feedback current Ifb.

The LLC converter control circuit 100 according to a second embodiment or second embodiments may further include the negative current duration detection circuit 180. The negative current duration detection circuit 180 may be configured to generate the threshold voltage Vth2 that corresponds to a time elapsing from a moment at which the first driving signal VgH changes in value to a moment at which the zero cross signal ZC changes in value. The edge delay circuit 130 may generate the delay signal Vd that is the first signal Va delayed by a time proportional to the threshold voltage Vth2.

This configuration allows the amount of change in the feedback current Ifb with respect to the output current Io to increase, that is, to become steeper in slope, at extremely light load in the LLC converter control circuit 100. This helps to allow the LLC converter control circuit 100 to determine the extremely light load condition more accurately, based on the feedback current Ifb.

The LLC converter control circuit 100 according to a third embodiment or third embodiments may further include the period detection circuit 190 and the comparator circuit 150. The period detection circuit 190 may be configured to generate the proportional voltage Vpp proportional to a switching period of the resonant circuit Re, based on the second driving signal VgL. The comparator circuit 150 may be configured to perform a comparison between the proportional voltage Vpp and the ramp voltage Vct. The driving signal generation circuit 160 may be configured to switch a state of each of the first driving signal VgH and the second driving signal VgL at a timing of rising of a comparison result indicating a result of the comparison performed by the comparator circuit 150.

This configuration allows the comparator circuit 150 of the LLC converter control circuit 100 to compare the ramp voltage Vct with the proportional voltage Vpp proportional to the switching period. This helps to accurately detect a light load condition regardless of the input voltage.

The LLC converter control circuit 100 according to a fourth embodiment may further include the period detection circuit 190, the negative current duration detection circuit 180, and the comparator circuit 150. The period detection circuit 190 may be configured to generate the proportional voltage Vpp proportional to the switching period of the resonant circuit Re, based on the second driving signal VgL. The negative current duration detection circuit 180 may be configured to generate the threshold voltage Vth2 that corresponds to a time elapsing from a moment at which the second driving signal VgL changes in value to a moment at which the zero cross signal ZC changes in value. The edge delay circuit 130 may generate the delay signal Vd that is the first signal Va delayed by a time proportional to the threshold voltage Vth2. The comparator circuit 150 may be configured to perform a comparison between the proportional voltage Vpp and the ramp voltage Vct. The driving signal generation circuit 160 may be configured to switch the state of each of the first driving signal VgH and the second driving signal VgL at a timing of rising of a comparison result indicating a result of the comparison performed by the comparator circuit 150.

This configuration allows the comparator circuit 150 of the LLC converter control circuit 100 to compare the ramp voltage Vct with the proportional voltage Vpp proportional to the switching period. This helps to accurately detect a light load condition regardless of the input voltage. Further, this configuration allows the negative current duration detection circuit 180 and the period detection circuit 190 to share some components with each other in the LLC converter control circuit 100. This helps to achieve reduction in circuit scale.

The LLC converter control circuit 100 according a fifth embodiment may further include the period detection circuit 190, the negative current duration detection circuit 180, and the comparator circuit 150. The period detection circuit 190 may be configured to generate the proportional voltage Vpp proportional to the switching period of the resonant circuit Re, based on the first driving signal VgH. The negative current duration detection circuit 180 may be configured to generate the threshold voltage Vth2 that corresponds to a time elapsing from a moment at which the first driving signal VgH changes in value to a moment at which the zero cross signal ZC changes in value. The edge delay circuit 130 may generate the delay signal Vd that is the first signal Va delayed by a time proportional to the threshold voltage Vth2. The comparator circuit 150 may be configured to perform a comparison between the proportional voltage Vpp and the ramp voltage Vct. The driving signal generation circuit 160 may be configured to switch the state of each of the first driving signal VgH and the second driving signal VgL at a timing of rising of a comparison result indicating a result of the comparison performed by the comparator circuit 150.

This configuration allows the comparator circuit 150 of the LLC converter control circuit 100 to compare the ramp voltage Vct with the proportional voltage Vpp proportional to the switching period. This helps to accurately detect a light load condition regardless of the input voltage. Further, this configuration allows the negative current duration detection circuit 180 and the period detection circuit 190 to share some components with each other in the LLC converter control circuit 100. This helps to achieve reduction in circuit scale.

The LLC converter 10 according to a sixth embodiment includes the LLC converter control circuit 100 described above and the input power supply Vin. The LLC converter 10 further includes the half bridge circuit Hb including the high side switch QH and the low side switch QL. The LLC converter 10 further includes the resonant circuit Re. The resonant circuit Re is coupled between the output HB of the half bridge circuit Hb and the ground GND, and includes the primary winding Np of the transformer T and the resonant capacitor Cr that are coupled in series to each other. The LLC converter 10 further includes the first diode Ds1, the second diode Ds2, the output capacitor Co, the output voltage detection circuit 200, and the resonant current detection circuit 300. The first diode Ds1, the second diode Ds2, and the output capacitor Co are configured to rectify and smooth a current flowing through the secondary windings Ns1 and Ns2 of the transformer T. The output voltage detection circuit 200 is configured to detect the output voltage Vo. The resonant current detection circuit 300 is configured to detect the current flowing through the resonant circuit Re.

This configuration allows the amount of change in the feedback current Ifb to increase at near-zero load in the LLC converter 10. This helps to allow the LLC converter control circuit 100 to accurately determine an extremely light load condition, based on the amount of change in the feedback current Ifb.

An LLC converter control circuit according to one or more embodiments may have any of the following configurations.

(1)

An LLC converter control circuit configured to control a high side driving signal and a low side driving signal, based on a resonant-current-converted voltage, the high side driving signal being adapted to drive a high side switch, the low side driving signal being adapted to drive a low side switch, the resonant-current-converted voltage being a voltage as a resultant of conversion from a current flowing through a resonant circuit configured to resonate through alternate turning-on and turning-off of the high side switch and the low side switch,
the LLC converter control circuit including:
a current detection circuit configured to perform a comparison between the resonant-current-converted voltage and a ground potential and to output a zero cross signal whose voltage level is to change at a timing at which the resonant-current-converted voltage switches to a positive potential or a negative potential;
a synchronization signal generation circuit configured to output a first signal indicating a value that is a resultant of an exclusive OR operation on respective values of a first driving signal and the zero cross signal, the first driving signal being adapted to generate the high side driving signal;
an edge delay circuit configured to output a delay signal, the delay signal being the first signal delayed by a predetermined time;
a ramp voltage generation circuit configured to output a ramp voltage by charging and discharging a current supplied from a feedback terminal into and from a capacitor, based on a change in level of the delay signal; and
a driving signal generation circuit configured to generate, based on the ramp voltage, the first driving signal adapted to generate the high side driving signal and a second driving signal adapted to generate the low side driving signal.
   (2)

The LLC converter control circuit according to (1), further including a negative current duration detection circuit configured to generate a threshold voltage that corresponds to a time elapsing from a moment at which the first driving signal changes in value to a moment at which the zero cross signal changes in value, in which
the delay signal is the first signal delayed by a time proportional to the threshold voltage.
   (3)

The LLC converter control circuit according to (2), further including:
a period detection circuit; and
a comparator circuit, in which
the period detection circuit is configured to generate a proportional voltage proportional to a switching period of the resonant circuit, based on the second driving signal,
the comparator circuit is configured to perform a comparison between the proportional voltage and the ramp voltage, and
the driving signal generation circuit is configured to switch a state of each of the first driving signal and the second driving signal at a timing of rising of a comparison result indicating a result of the comparison performed by the comparator circuit.
   (4)

The LLC converter control circuit according to (1), further including:
a period detection circuit;
a negative current duration detection circuit; and
a comparator circuit, in which
the period detection circuit is configured to generate a proportional voltage proportional to a switching period of the resonant circuit, based on the second driving signal,
the negative current duration detection circuit is configured to generate a threshold voltage that corresponds to a time elapsing from a moment at which the second driving signal changes in value to a moment at which the zero cross signal changes in value,
the delay signal is the first signal delayed by a time proportional to the threshold voltage,
the comparator circuit is configured to perform a comparison between the proportional voltage and the ramp voltage, and
the driving signal generation circuit is configured to switch a state of each of the first driving signal and the second driving signal at a timing of rising of a comparison result indicating a result of the comparison performed by the comparator circuit.
   (5)

The LLC converter control circuit according to (1), further including:
a period detection circuit;
a negative current duration detection circuit; and
a comparator circuit, in which
the period detection circuit is configured to generate a proportional voltage proportional to a switching period of the resonant circuit, based on the first driving signal,
the negative current duration detection circuit is configured to generate a threshold voltage that corresponds to a time elapsing from a moment at which the first driving signal changes in value to a moment at which the zero cross signal changes in value,
the delay signal is the first signal delayed by a time proportional to the threshold voltage,
the comparator circuit is configured to perform a comparison between the proportional voltage and the ramp voltage, and
the driving signal generation circuit is configured to switch a state of each of the first driving signal and the second driving signal at a timing of rising of a comparison result indicating a result of the comparison performed by the comparator circuit.
   (6)

An LLC converter including:
the LLC converter control circuit according to any one of (1) to (5);
an input power supply;
a half bridge circuit including the high side switch and the low side switch;
the resonant circuit, the resonant circuit being coupled between an output of the half bridge circuit and a ground, and including a primary winding of a transformer and a resonant capacitor that are coupled in series to each other;
a first diode, a second diode, and an output capacitor that are configured to rectify and smooth a current flowing through a secondary winding of the transformer;
an output voltage detection circuit configured to detect an output voltage; and
a resonant current detection circuit configured to detect the current flowing through the resonant circuit.

An LLC converter control circuit and an LLC converter according to at least one embodiment of the disclosure each make it possible to accurately detect a value of an output current even in a region where the output current is small.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims. The limitations in the claims are to be interpreted broadly based on the language employed in the claims and not limited to examples described in this specification or during the prosecution of the application, and the examples are to be construed as non-exclusive. The use of the terms first, second, etc. do not denote any order or importance, but rather the terms first, second, etc. are used to distinguish one element from another. The term “substantially” and its variants are defined as being largely but not necessarily wholly what is specified as understood by one of ordinary skill in the art. The term “disposed on/provided on/formed on” and its variants as used herein refer to elements disposed directly in contact with each other or indirectly by having intervening structures therebetween. Moreover, no element or component in this disclosure is intended to be dedicated to the public regardless of whether the element or component is explicitly recited in the following claims.

1. An LLC converter control circuit that controls a high side driving signal and a low side driving signal, based on a resonant-current-converted voltage, the high side driving signal being adapted to drive a high side switch, the low side driving signal being adapted to drive a low side switch, the resonant-current-converted voltage being a voltage as a resultant of conversion from a current flowing through a resonant circuit that resonates through alternate turning-on and turning-off of the high side switch and the low side switch, the LLC converter control circuit comprising:
a current detection circuit that performs a comparison between the resonant-current-converted voltage and a ground potential and outputs a zero cross signal whose voltage level is to change at a timing at which the resonant-current-converted voltage switches to a positive potential or a negative potential;
a synchronization signal generation circuit that outputs a first signal indicating a value that is a resultant of an exclusive OR operation on respective values of a first driving signal and the zero cross signal, the first driving signal being adapted to generate the high side driving signal;
an edge delay circuit that outputs a delay signal, the delay signal being the first signal delayed by a predetermined time;
a ramp voltage generation circuit that outputs a ramp voltage by charging and discharging a current supplied from a feedback terminal into and from a capacitor, based on a change in level of the delay signal; and
a driving signal generation circuit that generates, based on the ramp voltage, the first driving signal adapted to generate the high side driving signal and a second driving signal adapted to generate the low side driving signal.

2. The LLC converter control circuit according to claim 1, further comprising a negative current duration detection circuit that generates a threshold voltage that corresponds to a time elapsing from a moment at which the first driving signal changes in value to a moment at which the zero cross signal changes in value, wherein
the delay signal is the first signal delayed by a time proportional to the threshold voltage.

3. The LLC converter control circuit according to claim 2, further comprising:
a period detection circuit; and
a comparator circuit, wherein
the period detection circuit generates a proportional voltage proportional to a switching period of the resonant circuit, based on the second driving signal,
the comparator circuit performs a comparison between the proportional voltage and the ramp voltage, and
the driving signal generation circuit switches a state of each of the first driving signal and the second driving signal at a timing of rising of a comparison result indicating a result of the comparison performed by the comparator circuit.

4. The LLC converter control circuit according to claim 1, further comprising:
a period detection circuit;
a negative current duration detection circuit; and
a comparator circuit, wherein
the period detection circuit generates a proportional voltage proportional to a switching period of the resonant circuit, based on the second driving signal,
the negative current duration detection circuit generates a threshold voltage that corresponds to a time elapsing from a moment at which the second driving signal changes in value to a moment at which the zero cross signal changes in value,
the delay signal is the first signal delayed by a time proportional to the threshold voltage,
the comparator circuit performs a comparison between the proportional voltage and the ramp voltage, and
the driving signal generation circuit switches a state of each of the first driving signal and the second driving signal at a timing of rising of a comparison result indicating a result of the comparison performed by the comparator circuit.

5. The LLC converter control circuit according to claim 1, further comprising:
a period detection circuit;
a negative current duration detection circuit; and
a comparator circuit, wherein
the period detection circuit generates a proportional voltage proportional to a switching period of the resonant circuit, based on the first driving signal,
the negative current duration detection circuit generates a threshold voltage that corresponds to a time elapsing from a moment at which the first driving signal changes in value to a moment at which the zero cross signal changes in value,
the delay signal is the first signal delayed by a time proportional to the threshold voltage,
the comparator circuit performs a comparison between the proportional voltage and the ramp voltage, and
the driving signal generation circuit switches a state of each of the first driving signal and the second driving signal at a timing of rising of a comparison result indicating a result of the comparison performed by the comparator circuit.

6. An LLC converter comprising:
the LLC converter control circuit according to claim 1;
an input power supply;
a half bridge circuit comprising the high side switch and the low side switch;
the resonant circuit, the resonant circuit being coupled between an output of the half bridge circuit and a ground, and including a primary winding of a transformer and a resonant capacitor that are coupled in series to each other;
a first diode, a second diode, and an output capacitor that rectify and smooth a current flowing through a secondary winding of the transformer;
an output voltage detection circuit that detects an output voltage; and
a resonant current detection circuit that detects the current flowing through the resonant circuit.
